(19) United States
(12) Patent Application Publication
(10) Pub. No.: US 2015/0270740 A1
(43) Pub. Date: Sep. 24, 2015

(54) METHOD FOR PREVENTING CROSS CONNECTION IN WIRELESS CHARGING

(71) Applicant: Samsung Electronics Co., Ltd., Gyeonggi-do (KR)

(72) Inventors: Kyung-Woo LEE, Seoul (KR); Kang-Ho BYUN, Gyeonggi-do (KR); Hee-Won JUNG, Gyeonggi-do (KR)

(73) Assignee: Samsung Electronics Co., Ltd.

(21) Appl. No.: 14/665,706

(22) Filed: Mar. 23, 2015

(30) Foreign Application Priority Data
Mar. 21, 2014 (KR) 10-2014-0033688

(51) Int. Cl. H02J 7/02; H04B 5/00

(52) U.S. Cl. CPC H02J 7/025; H04B 5/0037

(57) ABSTRACT

A method of preventing cross connection in wireless charging is provided. The method includes determining whether a load variation is sensed in a wireless power transmitter, transmitting a signal including identification information of the wireless power transmitter if the load variation is sensed, receiving a signal transmitted from at least one wireless power receiver, and performing a communication connection with the at least one wireless power receiver having transmitted the signal, if information included in the received signal matches the identification information of the wireless power transmitter.

### PRIORITY

This application claims priority under 35 U.S.C. §119(a) to a Korean Patent Application filed on Mar. 21, 2014 in the Korean Intellectual Property Office and assigned Serial No. 10-2014-0033688, the entire contents of which are incorporated herein by reference.

### BACKGROUND

1. Field of the Invention

The present invention relates generally to wireless charging, and more particularly, to a method for preventing cross connection in wireless charging.

2. Description of the Related Art

Due to their nature, mobile terminals such as portable phones and Personal Digital Assistants (PDAs) are powered by rechargeable batteries. To charge the batteries, the mobile terminals apply electrical energy to the batteries through chargers. Typically, the charger and the battery each have an exterior contact terminal and thus are electrically connected to each other through their contact terminals.

This contact-based charging scheme faces the problem of vulnerability of contact terminals to contamination of foreign materials and the resulting unreliable battery charging because the contact terminals protrude outward. Moreover, if the contact terminals are exposed to moisture, the batteries may not be charged properly.

To address the above problems, wireless charging or contactless charging technologies have recently been developed and applied to many electronic devices.

Such a wireless charging technology is based on wireless power transmission and reception. For example, once a portable phone is placed on a charging pad without being connected to an additional charging connector, its battery is automatically charged. Among wirelessly charged products, wireless electric toothbrushes and wireless electric shavers are well known. The wireless charging technology offers the benefits of increased waterproofness due to wireless charging of electronic products and enhanced portability due to no need for a wired charger for electronic devices. Further, it is expected that various relevant wireless charging technologies will be further developed in the upcoming era of electric vehicles.

There are mainly three wireless charging schemes: electromagnetic induction using coils, resonance-based, and Radio Frequency (RF)/microwave radiation based on conversion of electrical energy to microwaves.

To date, the electromagnetic induction-based wireless charging scheme has been most popular. However, considering recent successful experiments in wireless power transmission over microwaves at a distance of tens of meters in Korea and other overseas countries, it is foreseeable that every electronic product will be charged wirelessly at any time in any place in the near future.

Electromagnetic induction-based power transmission refers to power transfer between primary and secondary coils. When a magnet moves through a coil, current is induced. Based on this principle, a transmitter creates a magnetic field and a receiver produces energy by current induced by a change in the magnetic field. This phenomenon is called magnetic induction and power transmission based on magnetic induction is highly efficient in energy transfer.

In 2005, regarding resonance-based wireless charging, a system was suggested for wireless energy transfer from a charger at a distance of a few meters based on the resonance-based power transmission principle by the Coupled Mode Theory. Electromagnetic waves carrying electric energy were resonated, instead of sound. The resonant electrical energy is directly transferred only in the presence of a device having the same resonant frequency, while the unused electrical energy is reabsorbed into the electromagnetic field rather than being dispersed in the air. Thus, the resonant electrical energy does not affect nearby machines or humans, as compared to other electrical waves.

Wireless charging is currently an active research topic. However, there is a need for standards for wireless charging priority, detection of a wireless power transmitter/receiver, communication frequency selection between a wireless power transmitter and a wireless power receiver, wireless power control, selection of a matching circuit, and allocation of a communication time to each wireless power receiver in a single charging cycle. Particularly, there exists a need for developing standards for a configuration and procedure that allow a wireless power receiver to select a wireless power transmitter from which to receive wireless power.

A wireless power transmitter and a wireless power receiver may communicate with each other in a predetermined communication scheme, for example, by ZigBee or Bluetooth Low Energy (BLE). An out-band scheme such as ZigBee or BLE increases an available communication distance. Accordingly, even if a wireless power transmitter and a wireless power receiver are relatively far from each other, they may communicate. In other words, even if the wireless power transmitter is too far to transmit power wirelessly, the wireless power transmitter may communicate with the wireless power receiver.

Referring to FIG. 1, a first wireless power transmitter TX1 and a second wireless power transmitter TX2 are deployed. A first wireless power receiver RX1 is placed on the first wireless power transmitter TX1 and a second wireless power receiver RX2 is placed on the second wireless power transmitter TX2. The first wireless power transmitter TX1 should transmit power to the nearby first wireless power receiver RX1 and the second wireless power transmitter TX2 should transmit power to the nearby second wireless power receiver RX2. Accordingly, the first wireless power transmitter TX1 preferably communicates with the first wireless power receiver RX1 and the second wireless power transmitter TX2 preferably communicates with the second wireless power receiver RX2.

According to an increase in communication distance, the first wireless power receiver RX1 may join a wireless power network managed by the second wireless power transmitter TX2, while the second wireless power receiver RX2 may join a wireless power network managed by the first wireless power transmitter TX1. This is called cross-connection. As a result, the first wireless power transmitter TX1 may transmit power requested by the second wireless power receiver RX2, not by the first wireless power receiver RX1. If the capacity of the second wireless power receiver RX2 is larger than the capacity of the first wireless power receiver RX1, the first wireless power receiver RX1 may experience overcapacity. On the other hand, if the capacity of the second wireless power receiver RX2 is smaller than the capacity of the first wireless power receiver RX1, the first wireless power receiver RX1 receives power below its charging capacity.

### SUMMARY

The present invention has been made to address at least the above-mentioned problems and/or disadvantages and to provide at least the advantages described below. Accordingly, an aspect of the present invention is to provide a method for preventing cross connection in wireless charging by determining a cross-connected wireless power receiver in order to overcome a problem that may occur in cross connection.

In accordance with an aspect of the present invention, there is provided a method of preventing cross connection in wireless charging. The method includes determining whether a load variation is sensed in a wireless power transmitter, transmitting a signal including identification information of the wireless power transmitter if the load variation is sensed, receiving a signal transmitted from at least one wireless power receiver, and performing a communication connection with the at least one wireless power receiver having transmitted the signal, if information included in the received signal matches the identification information of the wireless power transmitter.

In accordance with another aspect of the present invention, there is provided a method of preventing cross connection in wireless charging. The method includes transmitting, by a wireless power transmitter, a short beacon signal, determining whether a load variation is sensed in the wireless power transmitter, transmitting, by the wireless power transmitter, a long beacon signal if the load variation is sensed, receiving a first signal transmitted from at least one wireless power receiver, transmitting a long beacon signal including identification information of the wireless power transmitter, corresponding to the reception of the first signal, receiving a second signal transmitted from at least one wireless power receiver, and performing a communication connection with the at least one wireless power receiver having transmitted the signal, if information included in the received second signal matches the identification information of the wireless power transmitter.

### BRIEF DESCRIPTION OF THE DRAWINGS

The above and other aspects, features and advantages of the present invention will be more apparent from the following description, taken in conjunction with the accompanying drawings, in which:

FIG. 1 is an illustration of cross-connection;

FIG. 2 is a block diagram of a wireless charging system;

FIG. 3A is a block diagram of a wireless power transmitter and a wireless power receiver according to an embodiment of the present invention;

FIG. 3B is a block diagram of a wireless power transmitter and a wireless power receiver according to an embodiment of the present invention;

FIG. 3C is a block diagram of a wireless power receiver according to another embodiment of the present invention;

FIG. 4 is a signal flow diagram of a wireless power transmitter and a wireless power receiver according to an embodiment of the present invention;

FIG. 5 is a flowchart of a method of a wireless power transmitter and a wireless power receiver according to another embodiment of the present invention;

FIG. 6 is a graph illustrating amounts of power applied by a wireless power transmitter with respect to a time axis;

FIG. 7 is a flowchart of a method of controlling a wireless power transmitter according to an embodiment of the present invention;

FIG. 8 is a graph illustrating amounts of power applied by a wireless power transmitter with respect to a time axis according to the method of FIG. 7;

FIG. 9 is a flowchart of a method of controlling a wireless power transmitter according to an embodiment of the present invention;

FIG. 10 is a graph illustrating amounts of power supplied by a wireless power transmitter with respect to a time axis according to the method of FIG. 9;

FIG. 11 is a block diagram of a wireless power transmitter and a wireless power receiver in a Stand Alone (SA) mode according to an embodiment of the present invention;

FIG. 12 is a graph illustrating amounts of power applied by a wireless power transmitter with respect to a time axis according to an embodiment of the present invention;

FIG. 13 is a flowchart of a method of determining a cross-connection according to an embodiment of the present invention;

FIG. 14 is a graph illustrating a method of determining cross-connection according to an embodiment of the present invention;

FIG. 15 is a flowchart of a method of determining cross-connection according to an embodiment of the present invention;

FIG. 16 is a graph illustrating a method of determining cross-connection according to an embodiment of the present invention;

FIG. 17 is a flowchart of a method of determining cross-connection according to an embodiment of the present invention;

FIG. 18 is a graph illustrating a method of determining cross-connection according to an embodiment of the present invention;

FIG. 19 is a flowchart of a method of determining cross-connection according to an embodiment of the present invention;

FIG. 20 is a graph illustrating a method of determining cross-connection according to an embodiment of the present invention; and

FIG. 21 is a graph illustrating a method of determining cross-connection according to an embodiment of the present invention.

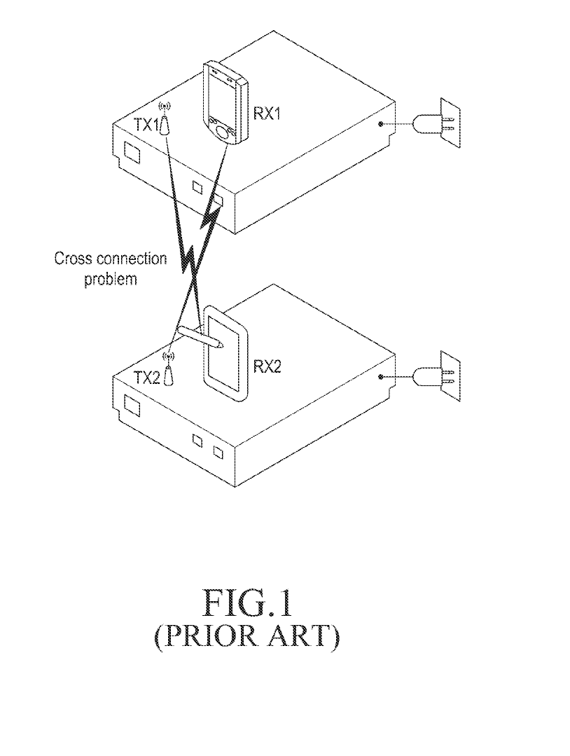

### DETAILED DESCRIPTION OF EMBODIMENTS OF THE PRESENT INVENTION

The following description with reference to the accompanying drawings is provided to assist in a comprehensive understanding of the present invention as defined by the appended claims and their equivalents. It includes various details to assist in that understanding but these are to be regarded as merely exemplary. Accordingly, those of ordinary skilled in the art will recognize that various changes and modifications of the present invention described herein can be made without departing from the scope and spirit of the present invention. In addition, descriptions of well-known functions and constructions are omitted for clarity and conciseness. Throughout the drawings, like reference numerals will be understood to refer to like parts, components, and structures.

The terms and words used in the following description and claims are not limited to their dictionary meanings, but, are merely used to enable a clear and consistent understanding of the present invention. Accordingly, it should be apparent to those skilled in the art that the following description of the present invention is provided for illustration purpose only and not for the purpose of limiting the present invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is indicated that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

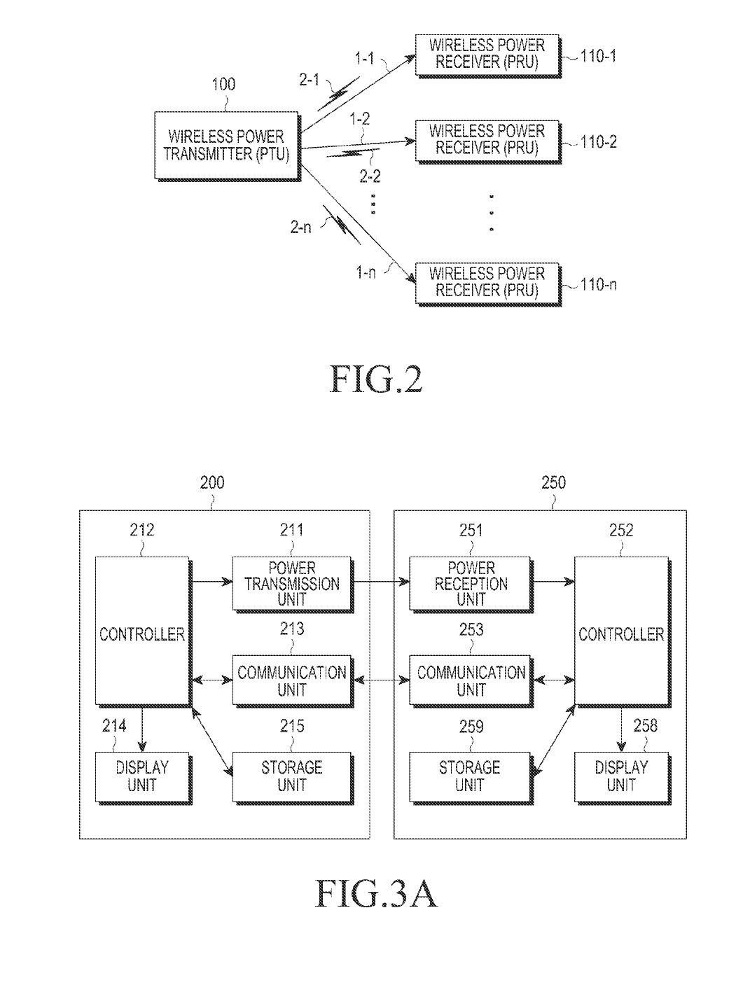

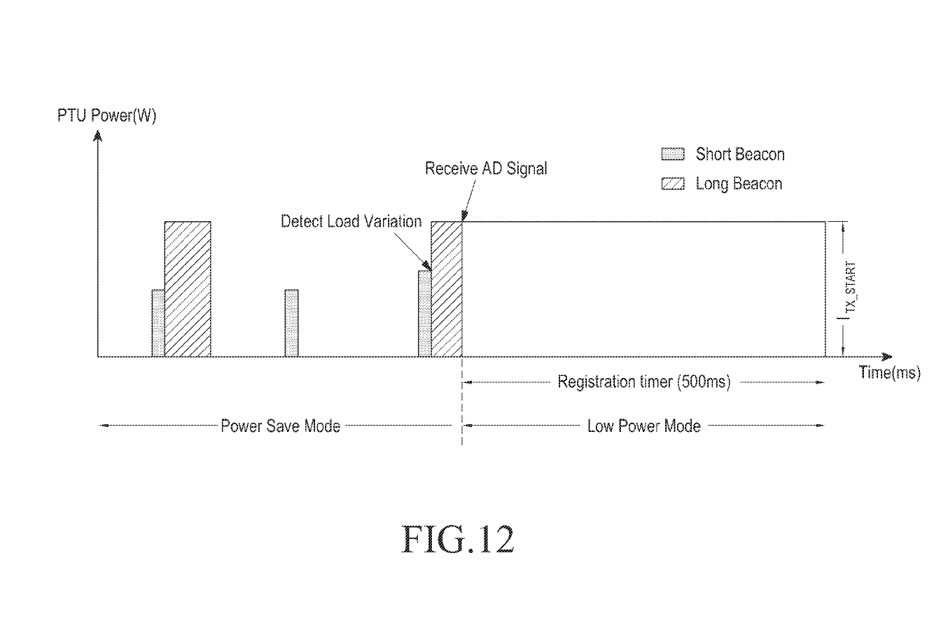

A description will first be given of the concept of a wireless charging system and a structure of a wireless power transmitter/receiver applicable to embodiments of the present invention with reference to FIGS. 2 to 11, followed by a detailed description of methods for determining cross-connection according to embodiments of the present invention with reference to FIGS. 12 to 21.

FIG. 2 is a block diagram of a wireless charging system.

Referring to FIG. 2, the wireless charging system includes a wireless power transmitter (or Power Transmitting Unit (PTU)) 100 and one or more wireless power receivers (or Power Receiving Units (PRUs)) 110-1, 110-2, . . . , and 110-n.

The wireless power transmitter 100 wirelessly transmits power 1-1, 1-2, . . . , and 1-n respectively to the wireless power receivers 110-1, 110-2, . . . , and 110-n. More specifically, the wireless power transmitter 100 wirelessly transmits power 1-1, 1-2, . . . , and 1-n only to wireless power receivers 110-1, 110-2, . . . , 110-n that have been authenticated in a predetermined authentication procedure.

The wireless power transmitter 100 establishes electrical connections to the wireless power receivers 110-1, 110-2, . . . , and 110-n. For example, the wireless power transmitter 100 may transmit wireless power in the form of electromagnetic waves to the wireless power receivers 110-1, 110-2, . . . , and 110-n.

The wireless power transmitter 100 conducts bi-directional communication with the wireless power receivers 110-1, 110-2, . . . , and 110-n. The wireless power transmitter 100 and the wireless power receivers 110-1, 110-2, . . . , and 110-n process or transmit/receive packets 2-1, 2-2, . . . , and 2-n configured in predetermined frames. The frames are described below in greater detail. A wireless power receiver 110-1, 110-2, . . . , 110-n may be configured as a mobile communication terminal, a Personal Digital Assistant (PDA), a Personal Multimedia Player (PMP), a smartphone, or the like.

The wireless power transmitter 100 applies power wirelessly to the plurality of wireless power receivers 110-1, 110-2, . . . , and 110-n. For example, the wireless power transmitter 100 transmits power to the plurality of wireless power receivers 110-1, 110-2, . . . , and 110-n by resonance. If the wireless power transmitter 100 adopts the resonance scheme, the distance between the wireless power transmitter 100 and the wireless power receivers 110-1, 110-2, . . . , and 110-n may be preferably 30 m or less. If the wireless power transmitter 100 adopts an electromagnetic induction scheme, the distance between the wireless power transmitter 100 and the wireless power receivers 110-1, 110-2, . . . , and 110-n may be preferably 10 cm or less.

The wireless power receivers 110-1, 110-2, . . . , and 110-n receive wireless power from the wireless power transmitter 100 and charge their internal batteries. Further, the wireless power receivers 110-1, 110-2, . . . , and 110-n transmit to the wireless power transmitter 100 a signal requesting wireless power transmission, information required for wireless power reception, wireless power receiver state information, or control information for the wireless power transmitter 100. Information of the transmitted signal is described below in greater detail.

Each of the wireless power receivers 110-1, 110-2, . . . , and 110-n also transmits a message indicating its charged state to the wireless power transmitter 100.

The wireless power transmitter 100 includes a display means such as a display and displays the state of each wireless power receiver based on the messages received from the wireless power receivers 110-1, 110-2, . . . , and 110-n. Further, the wireless power transmitter 100 may display a time expected until each of the wireless power receivers 110-1, 110-2, . . . , and 110-n is completely charged.

The wireless power transmitter 100 transmits a control signal for disabling a wireless charging function to the wireless power receivers 110-1, 110-2, . . . , and 110-n. Upon receipt of the control signal for disabling the wireless charging function from the wireless power transmitter 100, a wireless power receiver disables the wireless charging function.

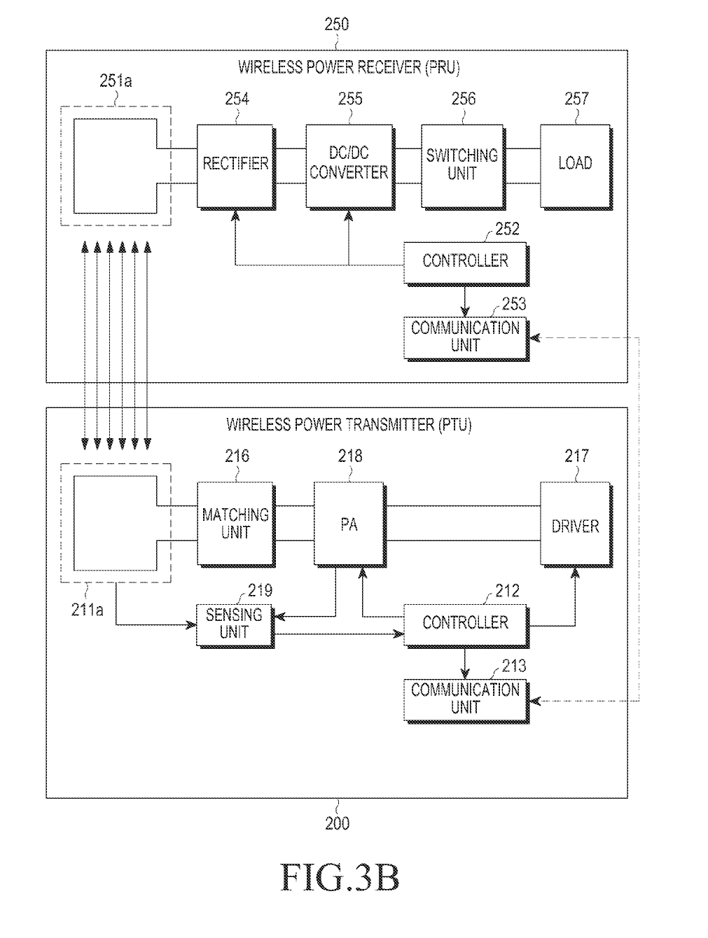

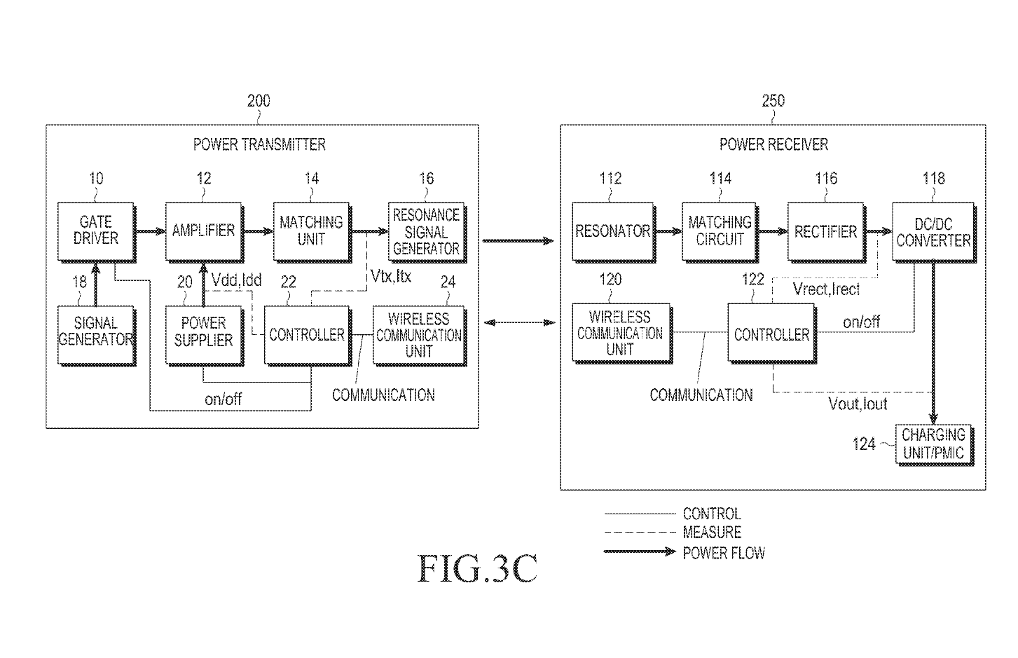

FIG. 3A is a block diagram of a wireless power transmitter and a wireless power receiver according to an embodiment of the present invention.

Referring to FIG. 3A, a wireless power transmitter 200 includes at least one of a power transmission unit 211, a controller 212, a communication unit 213, a display unit 214, and a storage unit 215.

The power transmission unit 211 supplies power required for the wireless power transmitter 200 and wirelessly supplies power to a wireless power receiver 250. The power transmission unit 211 supplies power in the form of Alternate Current (AC) waveforms or by converting power in Direct Current (DC) waveforms to power in AC waveforms by means of an inverter. The power transmission unit 211 may be implemented as a built-in battery or as a power reception interface so as to receive power externally and supply the power to other components. It will be understood by those skilled in the art that any means that can supply power in AC waveforms may be used as the power transmission unit 211.

The controller 212 provides overall control to the wireless power transmitter 200. The controller 212 controls an overall operation of the wireless power transmitter 200 using an algorithm, a program, or an application required for a control operation, read from the storage unit 215. The controller 212 may be configured as a Central Processing Unit (CPU), a microprocessor, or a mini computer.

The communication unit 213 communicates with the wireless power receiver 250 in a predetermined communication scheme. The communication unit 213 receives power information from the wireless power receiver 250. The power information may include information about at least one of the capacity, residual battery amount, use amount, battery capacity, and battery proportion of the wireless power receiver 250.

Further, the communication unit 213 transmits a charging function control signal for controlling the charging function of the wireless power receiver 250. The charging function control signal is a control signal that enables or disables the charging function by controlling a power reception unit 251 of the wireless power receiver 250. The power information may include information about insertion of a wired charging terminal, transition from a Stand Alone (SA) mode to a Non-Stand Alone (NSA) mode, error state release, and the like, as described below in detail. The charging function control signal is information related to a determination as to cross connection according to an embodiment of the present invention. For example, the charging function control signal may include IDentification (ID) information for determining a cross connection, setting information, and pattern or time information related to a load variation of the wireless power receiver 250, for cross-connection determination. In addition, according to an embodiment of the present invention, the communication unit 213 receives an advertisement signal from at least one wireless power receiver 250, where the advertisement signal includes information associated with the ID information of the wireless power transmitter 200.

The communication unit 213 receives a signal from another wireless power transmitter as well as the wireless power receiver 250.

The controller 212 displays a state of the wireless power receiver 250 on the display unit 214 based on a message received from the wireless power receiver 250 through the communication unit 213. Further, the controller 212 may display a time expected until the wireless power receiver 250 is completely charged on the display unit 214.

As illustrated in FIG. 3A, the wireless power receiver 250 includes at least one of a power reception unit 251, a controller 252, a communication unit 253, a display unit 258, and a storage unit 259.

The power reception unit 251 receives power wirelessly from the wireless power transmitter 200. The power reception unit 251 may receive power in the form of AC waveforms from the wireless power transmitter 200.

The controller 252 provides overall control to the wireless power receiver 250. The controller 252 controls an overall operation of the wireless power receiver 250 using an algorithm, a program, or an application required for a control operation, read from the storage unit 259. The controller 252 may be configured as a CPU, a microprocessor, or a mini computer.

According to an embodiment of the present invention, the controller 252 detects ID information of the wireless power transmitter 200 from a received power signal through the power reception unit 251.

The communication unit 253 communicates with the wireless power transmitter 200 in a predetermined communication scheme. The communication unit 253 transmits power information to the wireless power transmitter 200. The power information includes information about at least one of the capacity, residual battery amount, use amount, battery capacity, and battery proportion of the wireless power receiver 250.

Further, the communication unit 253 transmits a charging function control signal for controlling the charging function of the wireless power receiver 250. The charging function control signal is a control signal that enables or disables the charging function by controlling the power reception unit 251 of the wireless power receiver 250. The power information may include information about insertion of a wired charging terminal, transition from the SA mode to the NSA mode, error state release, and the like, as described below in detail. The charging function control signal may be information related to a determination as to cross connection according to an embodiment of the present invention. For example, the charging function control signal may include ID information for determining cross-connection, setting information, and pattern or time information related to a load variation of the wireless power receiver 250, for a cross connection determination. In addition, according to an embodiment of the present invention, the communication unit 253 transmits a signal including the ID information of the wireless power transmitter 200 detected by the controller 252 to the wireless power transmitter 200. For example, a signal including the ID information of the wireless power transmitter 200 may be an advertisement signal.

The controller 252 displays a state of the wireless power receiver 250 on the display unit 258. Further, the controller 252 may display a time expected until the wireless power receiver 250 is completely charged on the display unit 258.

Although it is illustrated in FIG. 3A that the power transmission unit 211 and the communication unit 213 are configured with different hardware to allow the wireless power transmitter 200 to communicate using an out-band scheme, this illustration is merely an example. In the present invention, the power transmission unit 211 and the communication unit 213 may be implemented with a single hardware to allow the wireless power transmitter 200 to communicate using an in-band scheme.

The wireless power transmitter 200 and the wireless power receiver 250 transmit and receive various signals, such that a process of the wireless power receiver 250 joining a wireless power network managed by the wireless power transmitter 200 and a process of charging based on wireless power transmission/reception may be performed, as is described below.

Moreover, while the structure of the wireless power transmitter 200 is illustrated in FIG. 3A, a more detailed structure of the wireless power transmitter 200 is illustrated in FIG. 3C and is described below.

FIG. 3B is a block diagram of the wireless power transmitter 200 and the wireless power receiver 250 according to an embodiment of the present invention.

Referring to FIG. 3B, the wireless power transmitter 200 includes at least one of a Transmission (Tx) resonator 211a, the controller 212 (for example, a Micro Controller Unit (MCU)), the communication unit 213 (for example, an out-of-band signaling unit), a matching unit 216, a driver (e.g. a power supply) 217, a Power Amplifier (PA) 218, and a sensing unit 219. The wireless power receiver 250 includes at least one of a Reception (Rx) resonator 251a, the controller 252, the communication unit 253, a rectifier 254, a DC/DC converter 255, a switching unit 256, and a load 257.

The driver 217 outputs DC power having a predetermined voltage value. The voltage value of the DC power output from the driver 217 is controlled by the controller 212.

A DC current output from the driver 217 is applied to the PA 218. The PA 218 amplifies the DC current with a predetermined gain. Further, the PA 218 converts DC power to AC power based on a signal received from the controller 212. Therefore, the PA 218 outputs AC power.

The matching unit 216 performs impedance matching. For example, the matching unit 216 controls impedance viewed from the matching unit 216 so that its output power has high efficiency or high power. The sensing unit 219 senses a load variation of the wireless power receiver 250 through the Tx resonator 211a or the PA 218 and provides the sensing result to the controller 212.

The matching unit 216 adjusts impedance under control of the controller 212. The matching unit 216 includes at least one of a coil and a capacitor. The controller 212 controls a connection state to at least one of the coil and the capacitor and thus performs impedance matching accordingly.

The Tx resonator 211a transmits AC power to the Rx resonator 251a. The Tx resonator 211a and the Rx resonator 251a are configured as resonant circuits having the same resonant frequency. For example, the resonant frequency may be determined to be 6.78 MHz.

The communication unit 213 communicates with the communication unit 253 of the wireless power receiver 250, for example, bi-directionally in 2.4 GHz (e.g., by Wireless Fidelity (WiFi), ZigBec, or Bluetooth (BT)/Bluetooth Low Energy (BLE)).

The Rx resonator 251a receives power for charging. According to an embodiment of the present invention, the Rx resonator 251a receives a signal including ID information of the wireless power transmitter 200. For example, the signal including the ID information of the wireless power transmitter 200 may be included in the power for charging.

The rectifier 254 rectifies wireless power received from the Rx resonator 251a to DC power. For example, the rectifier 254 may be configured as a diode bridge. The DC/DC converter 255 converts the rectified power with a predetermined gain. For example, the DC/DC converter 255 may convert the rectified power so that the voltage of its output is 5V. A minimum voltage value and a maximum voltage value that may be applied to the input of the DC/DC converter 255 may be preset.

The switching unit 256 connects the DC/DC converter 255 to the load 257. The switching unit 256 may be kept in an ON or OFF state under the control of the controller 252. The switching unit 256 may be omitted. If the switching unit 256 is in the ON state, the load 257 stores the converted power received from the DC/DC converter 255.

FIG. 3C is a block diagram of a wireless power transmitter 200 and a wireless power receiver 250 according to an embodiment of the present invention. In FIG. 3C, voltages and currents in a wireless power transmitter 200 and a wireless power receiver 250 used for checking a cross connection are illustrated.

Referring to FIG. 3C, a signal generator 18 including a Voltage Controlled Oscillator (VCO) or the like, an amplifier 12 for receiving a frequency signal in a predetermined range output from the signal generator 18 through a gate driver 10 and amplifying the received frequency signal with high power, a power supplier 20 for supplying power to provide the frequency signal output from the signal generator 18 into a resonance frequency signal determined by the controller 22, a matching unit 14 for performing impedance matching, a resonance signal generator 16 for transmitting power from the power supplier 10 to one or more power receiver 250 through a wireless resonance signal according to the high-power signal generated in the amplifier 12, and a controller 22 for collectively controlling a wireless power transmission operation of the power transmitter 200.

In particular, the controller 22 measures a voltage V_{dd} and a current I_{dd} of a signal generated in the power supplier 20, and monitors a current Iₜₓ and a voltage Vₜₓ of a wirelessly transmitted resonance signal. It is illustrated in FIG. 3C that measurement of the voltage V_{dd} and the current I_{dd} and monitoring of the current Iₜₓ, and the voltage Vₜₓ are performed by the controller 22, but a separate voltage/current measurement unit for the measurement and the monitoring may be added.

The wireless power transmitter 200 according to an embodiment of the present invention must perform charging with the wireless power receiver 250 positioned in a charging area, for example, on a charging pad, but a plurality of wireless power receivers may exist within an effective distance of the charging area. In this case, cross connection may occur with a wireless power receiver other than the effective wireless power receiver 250 disposed on the charging pad. To prevent such cross connection, the controller 22, according to an embodiment of the present invention, identifies the effective wireless power receiver in the manner described below.

The controller 22 determines a cross connection before actual charging starts or while charging is being performed.

Embodiments of the present invention to be described in the detailed description of the present invention will be separately described as follows. In various embodiments of the present invention, amounts of power to be transmitted are changed before charging starts in the wireless power transmitter 200, such that the wireless power receiver 250 may identify the power transmitter 200. In addition, by transmitting information for identifying the wireless power transmitter 200 through a transmission power signal of the wireless power transmitter 200, the wireless power receiver 250 detects the ID information of the wireless power transmitter 200, included in the power signal. The wireless power receiver 250 transmits the detected ID information of the wireless power transmitter 200 to the wireless power transmitter 200 through the wireless communication unit 120. For example, the ID information of the wireless power transmitter 200 may be transmitted through the advertisement signal.

Through the foregoing process, the wireless power transmitter 200 maintains connection with the wireless power receiver 250 and then performs subsequent processes, only when the signal received from the wireless power receiver 250 includes the ID information of the wireless power transmitter 200. In contrast, if the signal received from the wireless power receiver 250 does not include the ID information of the wireless power transmitter 200, then the wireless power transmitter 200 terminates the connection with the wireless power receiver 250 to prevent a cross connection. In this case, since the wireless power transmitter 200 has already been cross-connected with the wireless power receiver 250, the wireless power transmitter 200 resets a wireless power transmission system. Thus, the wireless power transmitter 200 turns off the power thereof.

Alternatively, the wireless power transmitter 200 transmits a command for requesting a termination of cross connection to the wireless power receiver 250. The command for requesting termination of cross connection allows the wireless power receiver 250 to terminate a wireless power network connection with the wireless power transmitter 200 and to form a new wireless power network with another wireless power transmitter. The command for requesting a termination of cross connection is transmitted to the wireless power receiver 250 through an out-of-band signaling unit (for example, the wireless communication unit 24). The wireless power receiver 250 then resumes formation of a wireless power network with another wireless power transmitter.

The wireless power transmitter 200 transmits a command for forming a network with another wireless power transmitter or a command for switching to a standby mode to the wireless power receiver 250, thus excluding the cross-connected wireless power receiver.

According to an embodiment of the present invention, before charging starts, the controller 22 controls power transmission to drive the wireless power receiver 250.

More specifically, before charging starts, the controller 22 determines that the wireless power receiver 250 is positioned in a charging area after load detection. Once the controller 22 controls power transmission for driving the wireless power receiver 250, the wireless power receiver 250 is driven by receiving the power and performs a series of operations of joining the wireless power network. According to an embodiment of the present invention, ID information for identifying the wireless power transmitter 200 is transmitted through a power signal (for example, a long beacon signal) for driving the wireless power receiver 250. Thereafter, the wireless power receiver 250 transmits a searching frame for searching for a nearby wireless power transmitter or a join request frame for requesting to join in the wireless power network managed by the wireless power transmitter 200. When the wireless power receiver 250 performs a series of operations, the controller 22 of the wireless power transmitter 200 determines the effectiveness of the wireless power receiver 250 based on the ID information of the wireless power transmitter 200, included in a signal (for example, an advertisement signal) provided by the wireless power receiver 250.

The controller 22 controls transmission of the ID information of the wireless power receiver 200 through a transmission power signal to identify an effective wireless power receiver.

The controller 22 provides a voltage value to the power supplier 20 and controls an on/off state of the gate driver 10 to control amounts of transmission power or a power signal. In the present invention, changing the amounts of transmission power may be understood as changing the current I_{dd} or changing the current Iₜₓ of the resonance signal in the resonance signal generator 16 as well as changing the voltage V_{dd} output from the power supplier 20 by adjusting a power value provided to the power supplier 20 by the controller 22. For example, according to an embodiment of the present invention, based on ID information of the wireless power transmitter (PTU), the current Iₜₓ is modulated and transmitted. Modulation of the current Iₜₓ may use Pulse Position Modulation (PPM) or Pulse Width Modulation (PWM). To reduce a change in the power received by the wireless power receiver 250, modulation may be performed using Manchester coding or the like.

That is, in order for the wireless power receiver 250 to check the identification information of the wireless power transmitter 200, the current I_{dd} from the power supplier 10 is adjusted or the current Iₜₓ of the resonance signal is modulated.

The controller 22 adjusts power output from the amplifier 12 by controlling a duty cycle and level of the gate driver 10 input to the amplifier 12. When the AC current input to the resonance signal generator 16 is changed, a magnetic field strength is changed, such that the adjustment of the output power is performed by controlling the magnetic field strength. That is, through a change in the magnetic field strength in the wireless power transmitter 200, power received in the wireless power receiver 250, that is, a measurement value V_{rect} and a measurement value I_{rect} are changed.

Due to a change in the amount of transmission power, information included in a signal received from the power receiver 250 is analyzed, and then cross connection of the wireless power receiver 250 is determined based on the analysis result. In this way, subsequent processes after network formation are performed only for an effective wireless power receiver, and a connection is terminated for a cross-connected ineffective wireless power receiver to exclude the ineffective wireless power receiver from the wireless power network, thus preventing cross connection.

In an embodiment of the present invention, the wireless power receiver 250 transmits the detected ID information of the wireless power transmitter 200 through a report frame indicating a power reception state, after joining a wireless power network managed by the wireless power transmitter 200, and the ID information of the wireless power transmitter 200 detected in the wireless power receiver 250 may be transmitted through a searching frame, a join request frame, or the like. The ID information of the wireless power transmitter 200 detected in the wireless power receiver 250 may be included in a response message received in response to an information request from the wireless power transmitter 20, or may be received through an acknowledgement frame corresponding to a join response frame indicating that joining the wireless power network has been completed.

Meanwhile, if the wireless power receiver 250 has transmitted an initial reference voltage and an initial reference current, the controller 22 adjusts the amount of transmission power corresponding to the wireless power receiver 250. That is, if the initial reference voltage and the initial reference current are used, the controller 22 accurately knows how much the amount of transmission power needs to be reduced or increased suitably for the amount of power that may be received in the wireless power receiver 250. Herein, the initial reference voltage and the initial reference current are reference values that are used by the controller 22 to determine a power value supplied to the power supplier 20 and to provide the determined power value to the power supplier 20 for adjustment of the voltage V_{dd} to be output from the power supplier 20. The initial reference voltage and the initial reference current are transmitted through a frame transmitted from the wireless power receiver 250 to the wireless power transmitter 200 through the wireless communication unit 120, and a type of the frame may not be fixed if the frame is transmitted to the wireless power transmitter 200.

To communicate with the wireless communication unit 120 of the wireless power receiver 250 in association with a wireless power transmission operation under control of the controller 22, the wireless power transmitter 200 includes a wireless communication unit 24 configured using one wireless short-range communication scheme selected from among wireless short-range communication schemes (e.g. Bluetooth). The resonance signal generator 16 includes a charging substrate for disposing the wireless power receiver 250 on the resonance signal generator 16.

The controller 22 of the wireless power transmitter 200 may include an MCU, and an operation for identifying an effective wireless power receiver to prevent cross connection according to the present invention is described below.

The wireless power receiver 250 includes a resonator 112 for receiving a wireless resonance signal transmitted from the resonance signal generator 16 of the wireless power transmitter 200, a rectifier 116 for rectifying AC power into DC power upon receiving an AC signal through the resonator 112 and a matching circuit 114, a DC/DC converter 118 (or a static voltage generator) for converting the power output from the rectifier 116 into operating power (for example, +5 V) desired by a portable terminal to which the wireless power receiver is applied, a charging unit/Power Management Integrated Circuit (PMIC) 124 for performing charging with the operating power, and a controller 122 for measuring an input voltage Vᵢₙ that is input to the DC/DC converter 118 and an output voltage Vₒᵤₜ and an output current Iₒᵤₜ that are output from the DC/DC converter 118. The controller 122 may include an MCU, and determines a power reception state according to the measured voltage V_{rect}/current I_{rect} and provides information about the power reception state to the wireless power transmitter 200.

To communicate with the wireless power transmitter 200 in association with the wireless power reception operation under control of the controller 122, the wireless power receiver 250 includes a wireless communication unit 120 configured using a wireless short-range communication scheme selected from among wireless short-range communication schemes (e.g. Bluetooth). Upon receiving power from the wireless power transmitter 200, the controller 122 according to an embodiment of the present invention detects identification information of the wireless power transmitter 200, included in the received power signal, and transmits the detected identification information in a preset signal (for example, an advertisement signal) to the wireless power transmitter 200 through the wireless communication unit 120. That is, the controller 122 of the wireless power receiver 250 provides information associated with the received power signal used for the wireless power transmitter 200 to determine cross connection.

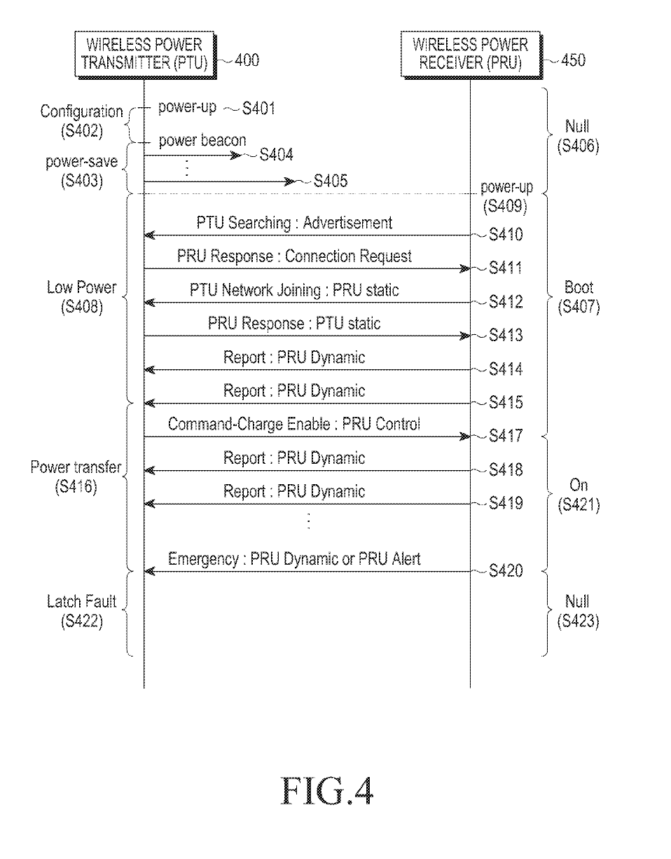

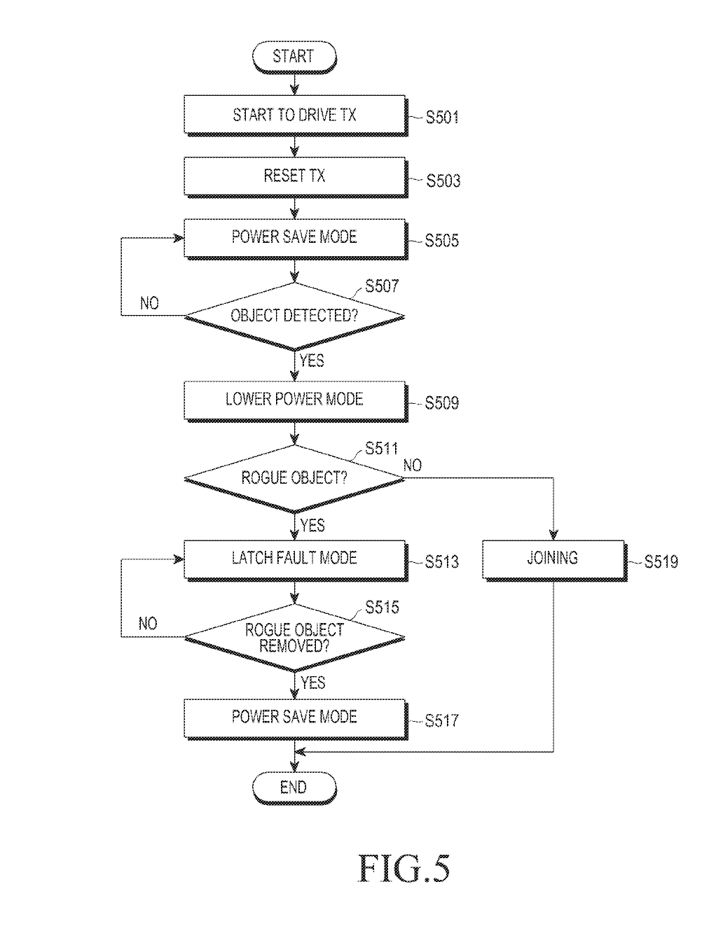

FIG. 4 is a signal flow diagram of a wireless power transmitter and a wireless power receiver according to an embodiment of the present invention.

Referring to FIG. 4, a wireless power transmitter 400 is powered on or powered up in step S401. Upon power-on, the wireless power transmitter 400 configures an environment in step group S402.

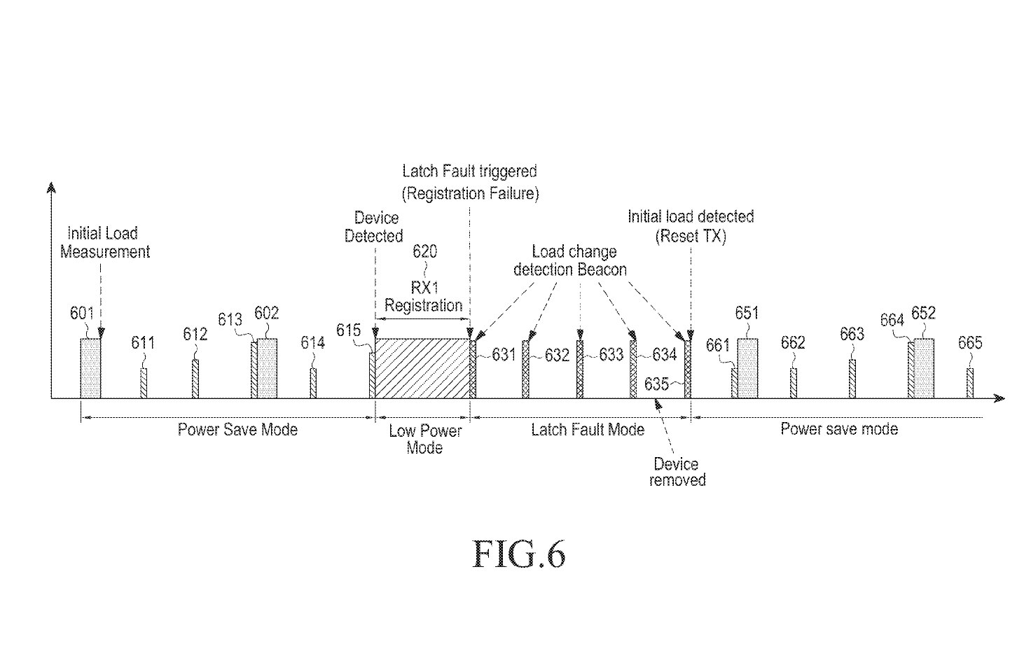

The wireless power transmitter 400 enters power save mode in group step S403. In the power save mode, the wireless power transmitter 400 applies different types of power beacons for detection, with their respective periods, which are described below in greater detail with reference to FIG. 6. For example, the wireless power transmitter 400 transmits power beacons S404 and S405 for detection (for example, short beacons or long beacons) and the power beacons S404 and S405 may have different power values. One or both of the power beacons S404 and S405 for detection may have sufficient power to drive a communication unit of a wireless power receiver 450. For example, the wireless power receiver 450 communicates with the wireless power transmitter 400 by driving its communication unit by means of one or both of the power beacons S404 and S405 for detection. This state is referred to as a null state in group step S406.

The wireless power transmitter 400 detects a load variation caused by disposition of the wireless power receiver 450. The wireless power transmitter 400 enters a low power mode in group step S408. The low power mode is described below in greater detail with reference to FIG. 6. The wireless power receiver 450 drives the communication unit with power received from the wireless power transmitter 400 in step S409.

The wireless power receiver 450 transmits a PTU searching signal to the wireless power transmitter 400 in step S410. The wireless power receiver 450 transmits the PTU searching signal by a BLE-based ADvertisement (AD) signal. The wireless power receiver 450 transmits the PTU searching signal periodically until it receives a response signal from the wireless power transmitter 400 or a predetermined time period lapses. According to an embodiment of the present invention, the wireless power receiver 250 detects ID information of the wireless power transmitter 400, included in a beacon signal transmitted from the wireless power transmitter 400, and transmits the detected ID information through the advertisement signal. Upon receipt of the PTU searching signal from the wireless power receiver 450, the wireless power transmitter 400 transmits a PRU response signal in step S411. The PRU response signal establishes a connection between the wireless power transmitter 400 and the wireless power receiver 450.

The wireless power receiver 450 transmits a PRU static signal in step S412. The PRU static signal indicates a state of the wireless power receiver 450 and requests joining a wireless power network managed by the wireless power transmitter 400.

The wireless power transmitter 400 transmits a PTU static signal in step S413. The PTU static signal indicates capabilities of the wireless power transmitter 400.

Once the wireless power transmitter 400 and the wireless power receiver 450 transmit and receive the PRU static signal and the PTU static signal, the wireless power receiver 450 transmits a PRU dynamic signal periodically in steps S414 and S415. The PRU dynamic signal includes at least one parameter measured by the wireless power receiver 450. For example, the PRU dynamic signal may include information about a voltage at the output of a rectifier of the wireless power receiver 450. The state of the wireless power receiver 450 is referred to as a boot state in group step S407.

The wireless power transmitter 400 enters a power transfer mode in group step S416. The wireless power transmitter 400 transmits a PRU control signal commanding charging to the wireless power receiver 450 in step S417. In the power transfer mode, the wireless power transmitter 400 transmits charging power.

The PRU control signal transmitted by the wireless power transmitter 400 includes information that enables/disables charging of the wireless power receiver 450 and permission information. The PRU control signal is transmitted each time a charged state is changed. For example, the PRU control signal may be transmitted every 250 ms or upon occurrence of a parameter change. The PRU control signal may be configured to be transmitted within a predetermined threshold time, for example, within 1 second, even though no parameter is changed.

The wireless power receiver 450 changes a setting according to the PRU control signal and transmits a PRU dynamic signal to report a state of the wireless power receiver 450 in steps S418 and S419. The PRU dynamic signal transmitted by the wireless power receiver 450 includes information about at least one of a voltage a current, a wireless power receiver state, and a temperature. The state of the wireless power receiver 450 is referred to as an ON state.

The PRU dynamic signal may have the following data structure illustrated in Table 1 below.

TABLE 1

| Field | octets | description | use | units |
|---|---|---|---|---|
| optional | 1 | defines which optional | mandatory | |
| fields | | fields are populated | | |
| Vrect | 2 | DC voltage at the output | mandatory | mV |
| | | of the rectifier. | | |
| Irect | 2 | DC current at the output | mandatory | mA |
| | | of the rectifier. | | |
| Vout | 2 | voltage at charge battery | optional | mV |
| | | port | | |
| Iout | 2 | current at charge battery | optional | mA |
| | | port | | |
| temperature | 1 | temperature of PRU | optional | Deg C. |
| | | | | from −10 C. |
| Vrect | 2 | The current dynamic | optional | mV |
| min dyn | | minimum rectifier | | |
| | | voltage desired | | |
| Vrect | 2 | desired Vrect (dynamic | optional | mV |
| set dyn | | value) | | |
| Vrect | 2 | The current dynamic | optional | mV |
| high dyn | | maximum rectifier | | |
| | | voltage desired | | |
| PRU alert | 1 | warnings | mandatory | Bit field |
| RFU | 3 | undefined | | |

Referring to Table 1, the PRU dynamic signal includes one or more fields. The fields provide optional field information, information about a voltage at the output of the rectifier of the wireless power receiver, information about a current at the output of the rectifier of the wireless power receiver, information about a voltage at the output of the DC/DC converter of the wireless power receiver, information about a current at the output of the DC/DC converter of the wireless power receiver, temperature information, information about a minimum voltage value Vrect_min_dyn at the output of the rectifier of the wireless power receiver, information about an optimum voltage value Vrect_set_dyn at the output of the rectifier of the wireless power receiver, information about a maximum voltage value Vrect_high_dyn at the output of the rectifier of the wireless power receiver, and warning information. The PRU dynamic signal includes at least one of the above fields.

For example, at least one voltage set value that has been determined according to a charging situation (for example, the information about a minimum voltage value Vrect_min_dyn at the output of the rectifier of the wireless power receiver, the information about an optimum voltage value Vrect_set_dyn at the output of the rectifier of the wireless power receiver, and the information about a maximum voltage value Vrect_high_dyn at the output of the rectifier of the wireless power receiver) are transmitted in the at least one field of the PRU dynamic signal. Upon receipt of the PRU dynamic signal, the wireless power transmitter adjusts a wireless charging voltage to be transmitted to each wireless power receiver based on the voltage value set in the PRU dynamic signal.

Among the fields, PRU Alert is configured in the data structure illustrated in Table 2 below.

TABLE 2

| 7 | 6 | 5 | 4 | 3 | 2 | 1 | 0 |
|---|---|---|---|---|---|---|---|
| over- | over- | over-tem- | Charge | TA | Tran- | restart | RFU |
| voltage | current | perature | Complete | detect | sition | request | |

Referring to Table 2 above, PRU Alert includes a bit for a restart request, a bit for a transition, and a bit for a Travel Adapter (TA) detect. The TA detect bit indicates that a wireless power receiver has been connected to a wired charging terminal in the wireless power transmitter that provides wireless charging. The Transition bit indicates to the wireless power transmitter that a communication Integrated Circuit (IC) of the wireless power receiver is reset before the wireless power receiver transitions from the SA mode to the NSA mode. Finally, the restart request bit indicates that the wireless power transmitter is ready to resume charging of the wireless power receiver, when the wireless power transmitter that has discontinued charging by reducing transmission power due to overcurrent or overtemperature returns to a normal state.

PRU Alert may also be configured in the data structure illustrated in Table 3 below.

TABLE 3

| 7 | 6 | 5 | 4 | 3 | 2 | 1 | 0 |
|---|---|---|---|---|---|---|---|
| PRU | PRU | PRU | PRU | Charge | Wired | Mode | Mode |
| over- | over- | over-tem- | Self | Com- | Charger | Tran- | Tran- |
| voltage | current | perature | Protec- | plete | Detect | sition | sition |
| | | | tion | | | Bit 1 | Bit 0 |

Referring to Table 3 above, PRU Alert includes the fields of overvoltage, overcurrent, overtemperature, PRU Self Protection, Charge Complete, Wired Charger Detect, and Mode Transition. If the overvoltage field is set to “1,” this indicates that the voltage Vrect of the wireless power receiver has exceeded an overvoltage limit. The overcurrent and overtemperature fields may be set in the same manner as the overvoltage field. PRU Self Protection indicates that the wireless power receiver protects itself by directly reducing power affecting a load. In this case, the wireless power transmitter does not need to change a charged state.

According to an embodiment of the present invention, bits for Mode Transition may be set to a value indicating the duration of a mode transition to the wireless power transmitter. The Mode Transition bits may be configured as illustrated in Table 4 below.

TABLE 4

| Value (Bit) | Mode Transition Bit Description |
|---|---|
| 00 | No Mode Transition |
| 01 | 2 s Mode Transition time limit |
| 10 | 3 s Mode Transition time limit |
| 11 | 6 s Mode Transition time limit |

Referring to Table 4 above, if the Mode Transition bits are set to “00,” this indicates no mode transition. If the Mode Transition bits are set to “01,” this indicates that a time limit for completion of a mode transition is 2 seconds. If the Mode Transition bits are set to “10,” this indicates that the time limit for completion of a mode transition is 3 seconds. If the Mode Transition bits are set to “11,” this indicates that the time limit for completion of a mode transition is 6 seconds.

For example, if a mode transition takes 3 seconds or less, the Mode Transition bits may be set to “10.” Before starting a mode transition, the wireless power receiver may make sure that no impedance shift will occur during the mode transition by changing an input impedance setting to match a 1.1 W power draw. Accordingly, the wireless power transmitter adjusts power ITX_COIL for the wireless power receiver according to this setting and thus may maintain the power ITX_COIL for the wireless power receiver during the mode transition.

Therefore, once a mode transition duration is set by the Mode Transition bits, the wireless power transmitter maintains the power ITX_COIL for the wireless power receiver during the mode transition duration, for example, for 3 seconds. In other words, even though the wireless power transmitter does not receive a response from the wireless power receiver for 3 seconds, the wireless power transmitter maintains a connection to the wireless power receiver. However, after the mode transition duration lapses, the wireless power transmitter ends the power transmission, considering that the wireless power receiver is a rogue object.

The wireless power receiver 450 senses the generation of an error. The wireless power receiver 450 transmits a warning signal to the wireless power transmitter 400 in step S420. The warning signal may be transmitted by a PRU dynamic signal or an alert signal. For example, the wireless power receiver 450 transmits the PRU Alert field illustrated in Table 1 above to indicate an error state to the wireless power transmitter 400 or a stand-alone warning signal indicating an error state to the wireless power transmitter 400. Upon receipt of the warning signal, the wireless power transmitter 400 enters a latch fault mode in step S422. The wireless power receiver 450 may enter a null state in step S423.

FIG. 5 is a flowchart of a method of a wireless power transmitter and a wireless power receiver according to an embodiment of the present invention. The control method of FIG. 5 is described in detail below with reference to FIG. 6. FIG. 6 is a graph illustrating amounts of power applied by the wireless power transmitter with respect to a time axis.

Referring to FIG. 5, the wireless power transmitter starts to operate in step S501. Further, the wireless power transmitter resets an initial setting in step S503 and enters the power save mode in step S505. The wireless power transmitter applies different types of power having different power amounts to a power transmitter in the power save mode. For example, the wireless power transmitter may apply a second detection power 601 and 602 and a third detection power 611 to 615 to the power transmitter in FIG. 6. The wireless power transmitter may apply the second detection power 601 and 602 periodically with a second period. When the wireless power transmitter supplies the second detection power 601 and 602, the second detection power 601 and 602 may last for a second time duration. The wireless power transmitter may apply the third detection power 611 to 615 periodically with a third period. When the wireless power transmitter supplies the third detection power 611 to 615, the third detection power 611 to 615 may last for a third time duration. The third detection power 611 to 615 may have the same power value, or different power values as illustrated in FIG. 6.

After outputting the third detection power 611, the wireless power transmitter outputs the third detection power 612 having the same power amount. If the wireless power transmitter outputs third detection power having the same amount as described above, the third detection power may have a power amount sufficient to detect the smallest wireless power receiver, for example, a wireless power receiver of Category 1.

In contrast, after outputting the third detection power 611, the wireless power transmitter outputs the third detection power 612 having a different power amount. If the wireless power transmitter outputs different amounts of third detection power as described above, the respective power amounts of the third detection power may be sufficient to detect wireless power receivers of Category 1 to Category 5. For example, the third detection power 611 may have a power amount sufficient to detect a wireless power receiver of Category 5, the third detection power 612 may have a power amount sufficient to detect a wireless power receiver of category 3, and the third detection power 613 may have a power amount sufficient to detect a wireless power receiver of Category 1.

The second detection power 601 and 602 drives the wireless power receiver. More specifically, the second detection power 601 and 602 may have a power amount sufficient to drive the controller and/or the communication unit of the wireless power receiver.

The wireless power transmitter applies the second detection power 601 and 602 and the third detection power 611 to 615 respectively with the second and third periods to the wireless power receiver. If the wireless power receiver is placed on the wireless power transmitter, an impedance viewed from the wireless power transmitter may be changed. The wireless power transmitter detects an impedance shift during an application of the second detection power 601 and 602 and the third detection power 611 to 615. For example, the wireless power transmitter detects an impedance shift during an application of the third detection power 615. Therefore, the wireless power transmitter detects an object in step S507. If no object is detected in step S507, the wireless power transmitter is kept in the power save mode in which it applies different types of power periodically in step S505.

If the wireless power transmitter detects an object due to an impedance shift in step S507, the wireless power transmitter enters the low power mode. In the low power mode, the wireless power transmitter applies a driving power having a power amount sufficient to drive the controller and the communication unit of the wireless power receiver. For example, the wireless power transmitter applies a driving power 620 to the power transmitter in FIG. 6. The wireless power receiver receives the driving power 620 and drives the controller and/or the communication unit with the driving power 620. The wireless power receiver communicates with the wireless power transmitter with the driving power 620 in a predetermined communication scheme. For example, the wireless power receiver transmits and receives data required for authentication and joins a wireless power network managed by the wireless power transmitter based on the data. However, if a rogue object is placed instead of a wireless power receiver, data transmission and reception may not be performed. Therefore, the wireless power transmitter determines whether the object is a rogue object in step S511. For example, if the wireless power transmitter fails to receive a response from the object for a predetermined time, the wireless power transmitter determines the object to be a rogue object.

If the wireless power transmitter determines the object to be a rogue object in step S511, the wireless power transmitter enters the latch fault mode in step S513. In contrast, if the wireless power transmitter determines that the object is not a rogue object in step S511, the wireless power transmitter proceeds to a joining operation in step S519. For example, the wireless power transmitter applies first power 631 to 634 periodically with a first period in FIG. 6. The wireless power transmitter may detect an impedance shift during application of the first power. For example, if the rogue object is removed in step S515-Y, the wireless power transmitter detects an impedance shift and thus determines that the rogue object has been removed. In contrast, if the rogue object is not removed in step S515, the wireless power transmitter does not detect an impedance shift and thus determines that the rogue object has not been removed. If the rogue object has not been removed, the wireless power transmitter notifies a user that the wireless power transmitter is currently in an error state by performing at least one of illuminating a lamp or outputting a warning sound. Accordingly, the wireless power transmitter includes an output unit for illuminating a lamp and/or outputting a warning sound.

If it is determined that the rogue object has not been removed in step S515, the wireless power transmitter maintains the latch fault mode in step S513. In contrast, if the rogue object has been removed in step S515, the wireless power transmitter reenters the power save mode in step S517. For example, the wireless power transmitter applies a second power 651 and 652 and a third power 661 to 665 in FIG. 6.

As described above, if a rogue object is placed on the wireless power transmitter, instead of a wireless power receiver, the wireless power transmitter enters the latch fault mode. Further, the wireless power transmitter determines whether the rogue object has been removed based on an impedance shift that occurs according to power applied in the latch fault mode. That is, a condition of entry to the latch fault mode is the presence of a rogue object in the embodiment illustrated in FIGS. 5 and 6. Besides the presence of a rogue object, the wireless power transmitter may have many other conditions for entry to the latch fault mode. For example, the wireless power transmitter may be cross-connected to a mounted wireless power receiver. In this case, the wireless power transmitter also enters the latch fault mode.

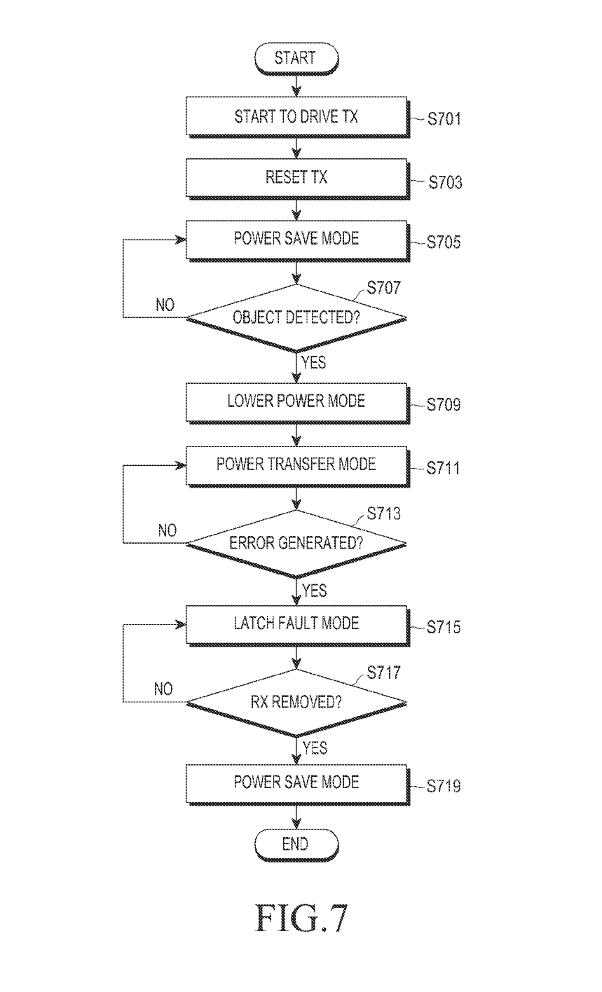

When the wireless power transmitter is cross-connected to a wireless power receiver, the wireless power transmitter must return to an initial state and the wireless power receiver should be removed. The wireless power transmitter may set cross connection of a wireless power receiver placed on another wireless power transmitter, that is, joining of a wireless power receiver placed on another wireless power transmitter in a wireless power network managed by the wireless power transmitter as a condition for entry to the latch fault mode. An operation of a wireless power transmitter upon occurrence of an error such as cross connection is described below with reference to FIG. 7.

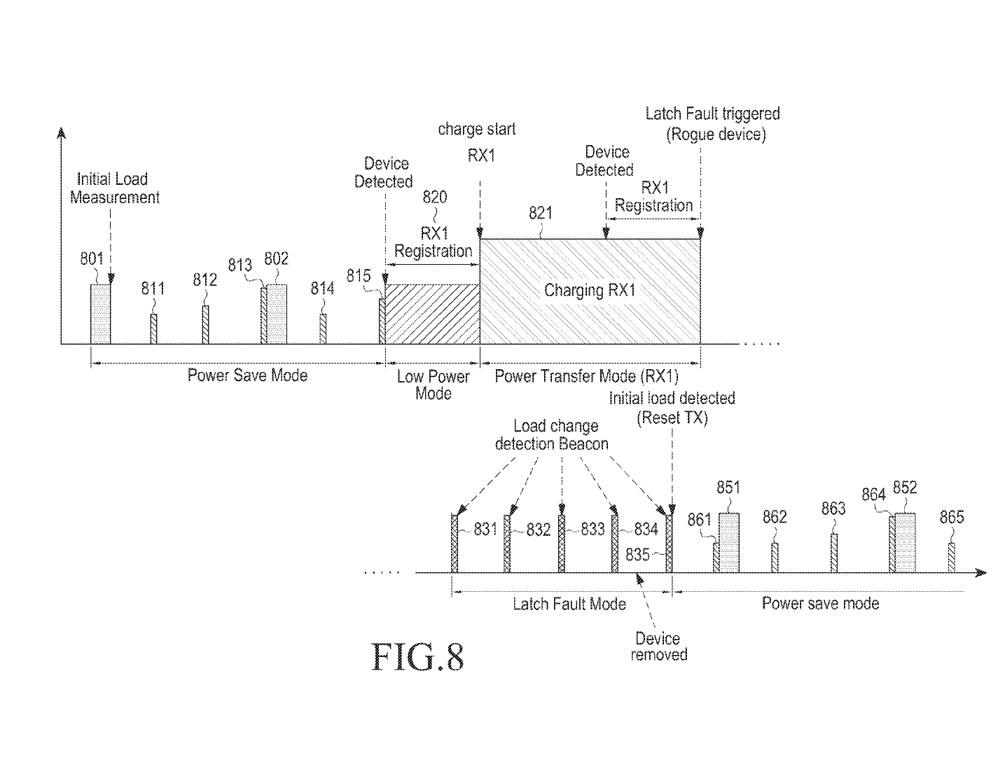

FIG. 7 is a flowchart of a method of controlling a wireless power transmitter according to an embodiment of the present invention. The control method of FIG. 7 is described in detail below with reference to FIG. 8. FIG. 8 is a graph illustrating amounts of power supplied by a wireless power transmitter with respect to a time axis according to the method of FIG. 7.

Referring to FIG. 7, the wireless power transmitter starts to operate in step S701. Further, the wireless power transmitter resets an initial setting in step S703 and enters the power save mode in step S705. The wireless power transmitter applies different types of power having different power amounts to the power transmitter in the power save mode. For example, the wireless power transmitter applies a second detection power 801 and 802 and a third detection power 811 to 815 to the power transmitter in FIG. 8. The wireless power transmitter applies the second detection power 801 and 802 periodically with a second period. When the wireless power transmitter applies the second detection power 801 and 802, the second detection power 801 and 802 may last for a second time duration. The wireless power transmitter may apply the third detection power 811 to 815 periodically with a third period. When the wireless power transmitter applies the third detection power 811 to 815, the third detection power 811 to 815 may last for a third time duration. The third detection power 811 to 815 may have the same power value, or different power values as illustrated in FIG. 8.

The second detection power 801 and 802 may drive the wireless power receiver. More specifically, the second detection power 801 and 802 may have a power amount sufficient to drive the controller and/or the communication unit of the wireless power receiver.

The wireless power transmitter applies the second detection power 801 and 802 and the third detection power 811 to 815 respectively with the second and third periods to the wireless power receiver. If the wireless power receiver is placed on the wireless power transmitter, an impedance viewed from the wireless power transmitter may be changed. The wireless power transmitter may detect an impedance shift during application of the second detection power 801 and 802 and the third detection power 811 to 815. For example, the wireless power transmitter detects an impedance shift during application of the third detection power 815. Therefore, the wireless power transmitter detects an object in step S707. If no object is detected in step S707, the wireless power transmitter is kept in the power save mode in which it applies different types of power periodically in step S705.

If the wireless power transmitter detects an object due to an impedance shift in step S707, the wireless power transmitter enters the low power mode in step S709. In the low power mode, the wireless power transmitter applies a driving power having a power amount sufficient to drive the controller and/or the communication unit of the wireless power receiver. For example, the wireless power transmitter applies driving power 820 to the power transmitter in FIG. 8. The wireless power receiver receives the driving power 820 and drives the controller and/or the communication unit with the driving power 820. The wireless power receiver communicates with the wireless power transmitter with the driving power 820 in a predetermined communication scheme. For example, the wireless power receiver transmits and receives data required for authentication and joins a wireless power network managed by the wireless power transmitter based on the data.

Subsequently, the wireless power transmitter enters the power transfer mode in which it transmits charging power in step S711. For example, the wireless power transmitter applies charging power 821 and the charging power 821 is transmitted to the wireless power receiver, as illustrated in FIG. 8.

In the power transfer mode, the wireless power transmitter determines whether an error has occurred. The error may be the presence of a rogue object, cross connection, an overvoltage state, an overcurrent state, or an overtemperature state. The wireless power transmitter includes a sensing unit for measuring voltage, current, or temperature. For example, the wireless power transmitter measures a voltage or current at a reference point and determines that a measured voltage or current exceeding a threshold satisfies an overvoltage or overcurrent condition or includes a temperature sensor, where the temperature sensor measures a temperature at a reference point of the wireless power transmitter. If the temperature at the reference point exceeds a threshold, the wireless power transmitter determines that an overtemperature condition is satisfied.

If the wireless power transmitter determines an overvoltage, an overcurrent, or an overtemperature state according to a measured voltage, current, or temperature value, the wireless power transmitter prevents an overvoltage, an overcurrent, or an overtemperature state by decreasing the wireless charging power by a predetermined value. If the voltage value of the decreased wireless charging power is below a set minimum value (for example, the minimum voltage value Vrect_min_dyn at the output of the rectifier of the wireless power receiver), wireless charging is discontinued and thus a voltage set value may be re-adjusted according to an embodiment of the present invention.

While presence of a rogue object on the wireless power transmitter is shown as an error in FIG. 8, an error is not limited to the presence of a rogue object. Thus, it will be readily understood to those skilled in the art that the wireless power transmitter may operate in a similar manner regarding the presence of a rogue object, cross connection, an overvoltage state, an overcurrent state, and an overtemperature state.

If no error occurs in step S713, the wireless power transmitter maintains the power transfer mode in step S711. In contrast, if an error occurs in step S713, the wireless power transmitter enters the latch fault mode in step S715. For example, the wireless power transmitter applies first power 831 to 835 as illustrated in FIG. 8. Further, the wireless power transmitter outputs an error notification including at least one of lamp illumination or a warning sound during the latch fault mode. If it is determined that the rogue object or the wireless power receiver has not been removed in step S717-N, the wireless power transmitter maintains the latch fault mode in step S715. In contrast, if it is determined that the rogue object or the wireless power receiver has been removed in step S717, the wireless power transmitter reenters the power save mode in step S719. For example, the wireless power transmitter applies a second power 851 and 852 and a third power 861 to 865 in FIG. 8.

An operation of a wireless power transmitter upon occurrence of an error during transmission of charging power is described above. Hereinafter, a description is provided of an operation of the wireless power transmitter, when a plurality of wireless power receivers placed on the wireless power transmitter receive charging power from the wireless power transmitter.

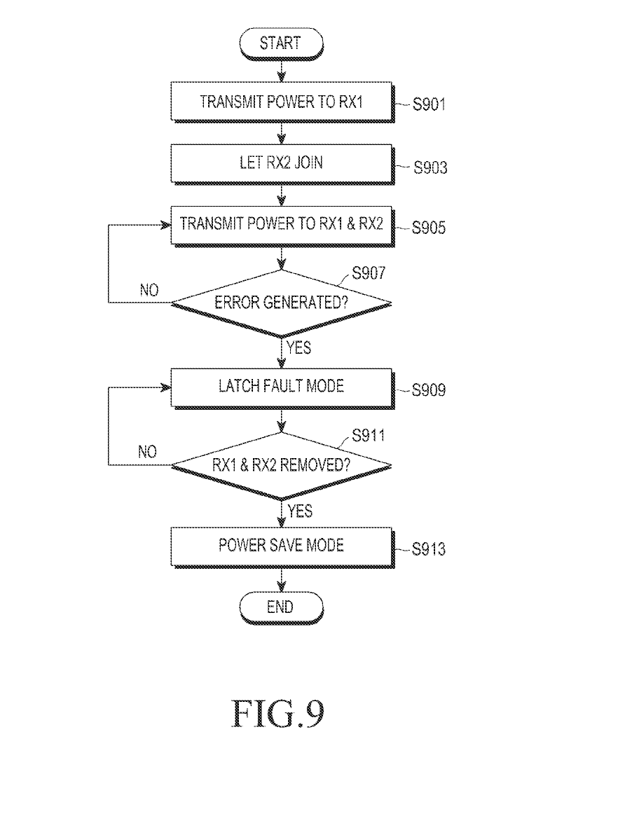

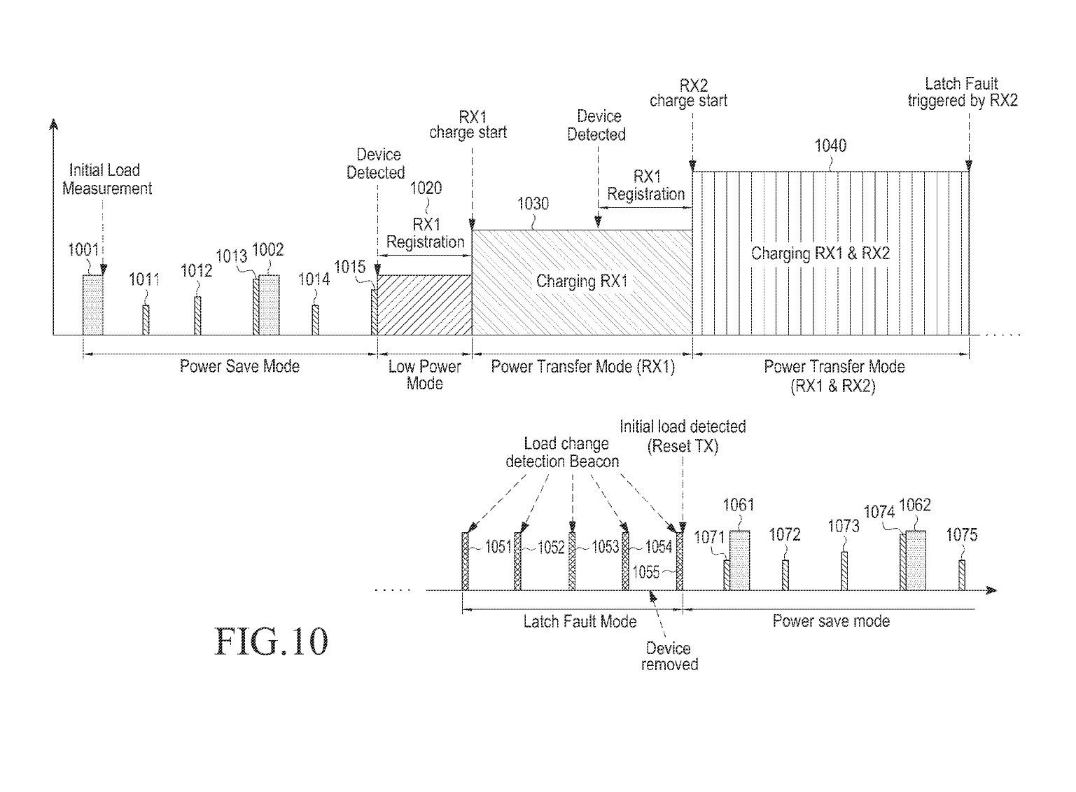

FIG. 9 is a flowchart of a method of controlling a wireless power transmitter according to an embodiment of the present invention. The control method of FIG. 9 is described in detail below with reference to FIG. 10. FIG. 10 is a graph illustrating amounts of power applied by a wireless power transmitter with respect to a time axis according to the method of FIG. 9.

Referring to FIG. 9, the wireless power transmitter transmits charging power to a first wireless power receiver in step S901. The wireless power transmitter also transmits charging power to a second wireless power receiver in step S905. More specifically, the wireless power transmitter applies the sum of charging power required for the first wireless power receiver and the second wireless power receiver to power receivers of the first and second wireless power receivers.

Steps S901 to S905 are illustrated in FIG. 10. For example, the wireless power transmitter maintains the power save mode in which the wireless power applies second detection power 1001 and 1002 and third detection power 1011 to 1015. Subsequently, the wireless power transmitter detects the first wireless power receiver and enters the low power mode in which the wireless power transmitter maintains detection power 1020. Then, the wireless power transmitter enters the power transfer mode in which the wireless power transmitter applies first charging power 1030. The wireless power transmitter detects the second wireless power receiver and allows the second wireless power receiver to join the wireless power network. In addition, the wireless power transmitter applies a second charging power 1040 being the sum of the charging power required for the first wireless power receiver and the second wireless power receiver.

Referring to FIG. 9, while transmitting charging power to both the first and second wireless power receivers in step S905, the wireless power transmitter may detect an error in step S907. As described above, the error may be the presence of a rogue object, cross connection, an overvoltage state, an overcurrent state, or an overtemperature state. If no error occurs in step S907, the wireless power transmitter continues to apply the second charging power 1040.

In contrast, if an error occurs in step S907, the wireless power transmitter enters the latch fault mode in step S909. For example, the wireless power transmitter applies a first power 1051 to 1055 with a first period as illustrated in FIG. 10. The wireless power transmitter determines whether both the first and second wireless power receivers have been removed in step S911. For example, the wireless power transmitter detects an impedance shift while applying the first power 1051 to 1055. The wireless power transmitter determines whether both the first and second wireless power receivers have been removed by checking whether the impedance has returned to an initial value.

If it is determined that both the first and second wireless power receivers have been removed in step S911, the wireless power transmitter enters the power save mode in step S913. For example, the wireless power transmitter applies a second detection power 1061 and 1062 and a third detection power 1071 to 1075 respectively with second and third periods, as illustrated in FIG. 10.

As described above, even though the wireless power transmitter applies charging power to a plurality of wireless power receivers, upon an occurrence of an error, the wireless power transmitter may readily determine whether a wireless power receiver or a rogue object has been removed.

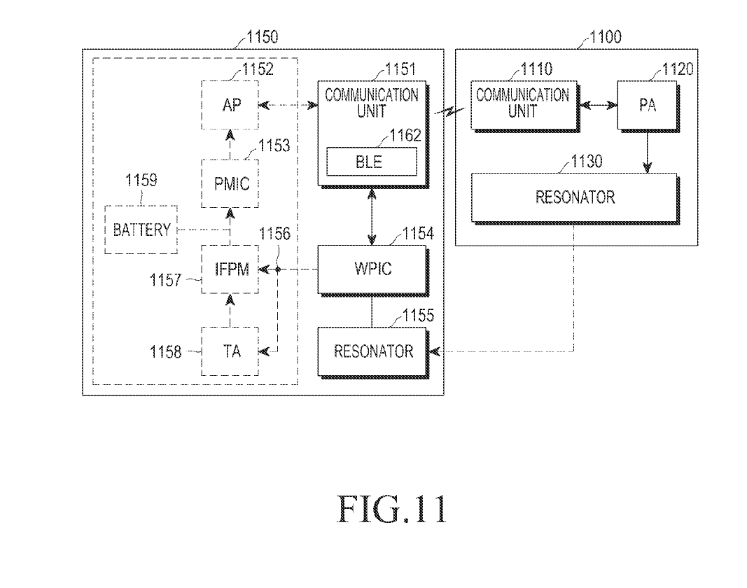

FIG. 11 is a block diagram of a wireless power transmitter and a wireless power receiver in the SA mode according to an embodiment of the present invention.

Referring to FIG. 11, a wireless power transmitter 1100 includes a communication unit 1110, a PA 1120, and a resonator 1130. A wireless power receiver 1150 includes a communication unit 1151, an Application Processor (AP) 1152, a Power Management Integrated Circuit (PMIC) 1153, a Wireless Power Integrated Circuit (WPIC) 1154, a resonator 1155, an Interface Power Management IC (IFPM) 1157, a TA 1158, and a battery 1159.

The communication unit 1110 of the wireless power transmitter 1100 may be configured as a WiFi/BT combo IC and may communicate with the communication unit 1151 of the wireless power receiver 1150 in a predetermined communication scheme, for example, in BLE. For example, the communication unit 1151 of the wireless power receiver 1150 transmits a PRU dynamic signal having the data structure illustrated in Table 1 described above to the communication unit 1110 of the wireless power transmitter 1100. As described above, the PRU dynamic signal includes at least one of voltage information, current information, and temperature information about the wireless power receiver 1150.

An output power value from the PA 1120 is adjusted based on the received PRU dynamic signal. For example, if an overvoltage, an overcurrent, or an overtemperature state is applied to the wireless power receiver 1150, a power value output from the PA 1120 decreases. If the voltage or current of the wireless power receiver 1150 is below a predetermined value, the power value output from the PA 1120 increases.

Charging power from the resonator 1130 of the wireless power transmitter 1100 is transmitted wirelessly to the resonator 1155 of the wireless power receiver 1150.

The WPIC 1154 rectifies the charging power received from the resonator 1155 and performs DC/DC conversion on the rectified charging power. The WPIC 1154 drives the communication unit 1151 or charges the battery 1159 with the converted power.

A wired charging terminal may be inserted into the TA 1158. A wired charging terminal such as a 30-pin connector or a Universal Serial Bus (USB) connector may be inserted into the TA 1158. The TA 1158 receives power from an external power source and charges the battery 1159 with the received power.

The IFPM 1157 processes the power received from the wired charging terminal and outputs the processed power to the battery 1159 and the PMIC 1153.

The PMIC 1153 manages power received wirelessly or wiredly and power applied to each component of the wireless power receiver 1150. The AP 1152 receives power information from the PMIC 1153 and controls the communication unit 1151 to transmit a PRU dynamic signal for reporting the power information.

A node 1156 connected to the WPIC 1154 is connected to the TA 1158. If a wired charging connector is inserted into the TA 1158, a predetermined voltage, for example, 5 V, is be applied to the node 1156. The WPIC 1154 determines whether the wired charging adaptor has been inserted by monitoring a voltage applied to the node 1156.

The AP 1152 has a stack of a predetermined communication scheme, for example, a WiFi/BT/BLE stack. Accordingly, for communication for wireless charging, the communication unit 1151 loads the stack from the AP 1152 and then communicates with the communication unit 1110 of the wireless power transmitter 1100, based on the stack by BT/BLE.

However, it may occur that data for wireless power transmission cannot be retrieved from the AP 1152 due to a power-off state of the AP 1152 or power is too low to maintain an ON state of the AP 1152 during retrieval of the data from a memory of the AP 1152 and use of the retrieved data.

If the residual power amount of the battery 1159 is below a minimum power limit as described above, the AP 1152 is turned off and the battery 1159 is wirelessly charged using some components for wireless charging in the wireless power receiver 1150, for example, the communication unit 1151, the WPIC 1154, and the resonator 1155. A state in which sufficient power cannot be supplied to turn on the AP 1152 is referred to as a dead battery state.

Because the AP 1152 is not operated in a dead battery state, the communication unit 1151 does not receive the stack of the predetermined communication scheme, for example, the WiFi/BT/BLE stack from the AP 1152. To guard against this case, a part of the stack of the predetermined communication scheme, for example, a BLE stack, may be fetched from the AP 1152 and stored in a memory 1162 of the communication unit 1151. Accordingly, the communication unit 1151 may communicate with the wireless power transmitter 1100 using the stack of the communication scheme stored in the memory 1162, that is, a wireless charging protocol, for wireless charging. The communication unit 1151 may have an internal memory. The BLE stack may be stored in a Read Only Memory (ROM) in the SA mode.

As described above, a mode in which the communication unit 1151 communicates using the stack of the communication scheme stored in the memory 1162 is referred to as the SA mode. Accordingly, the communication unit 1151 manages the charging procedure based on the BLE stack.

With reference to FIGS. 2 to 11, the concept of a wireless charging system and an example of a wireless power transmitter/receiver applicable to the present invention is described above. Hereinafter, a method for determining a cross connection according to an embodiment of the present invention is described in detail below with reference to FIGS. 12 to 21. Methods for determining cross connection described below with reference to FIGS. 12 through 21 may be implemented using at least some functions of the wireless charging system or the wireless power transmitter/receiver described above with reference to FIGS. 2 through 11.

FIG. 12 is a graph illustrating amounts of power applied by a wireless power transmitter with respect to a time axis according to an embodiment of the present invention.

Referring to FIG. 12, when a wireless power transmitter is powered on and enters the power save mode, the wireless power transmitter transmits power of a short beacon and/or power of a long beacon to a wireless power receiver.

For example, if the wireless power transmitter determines that the wireless power receiver does not cause a load variation, the wireless power transmitter transits power to the wireless power receiver by a long beacon. The wireless power receiver drives an MCU and/or a communication unit (e.g. BLE) by the power transmitted in the long beacon. In another example, if the PTU detects a load variation by a PRU as the PTU transmits a short beacon signal, the wireless power transmitter switches from a power save mode to a low power mode to transmit a long beacon signal. The PRU drives an MCU and/or a communication unit (e.g. BLE) using the power delivered through the long beacon signal.

The operated wireless power receiver notifies the wireless power transmitter that the wireless power receiver has received the power and has woken up by transmitting an ADvertisement (AD) signal to the wireless power transmitter.

Upon receipt of the AD signal from the wireless power receiver, ID information of the PTU included in the AD signal is checked to determine a cross connection according to various embodiments of the present invention described below. The AD signal includes the following fields illustrated in Table 5 and

TABLE 5

| Flags AD Type | Service Data AD Type | | | |
|---|---|---|---|---|
| Flags | WPT Service | GATT Primary | PRU RSSI | ADV |
| | 16-bit UUID | Service Handle | Parameters | Flags |

TABLE 6

| 7 | 6 | 5 | 4 | 3 | 2 | 1 | 0 |
|---|---|---|---|---|---|---|---|
| Imped- | Imped- | Imped- | Reboot | OVP | Time | RFU | RFU |
| ance | ance | ance | Bit | Status | Set | | |
| Shift | Shift | Shift | | (optional) | Support | | |
| Bit 2 | Bit 1 | Bit 0 | | | | | |

A 3-bit Impedance Shift is defined in Table 7 below.

TABLE 7

| Impedance Shift Bits | Definition |
|---|---|
| 000 | Can never create an impedance shift |
| 001 | Cat 1 PRU |
| 010 | Cat 2 PRU |
| 011 | Cat 3 PRU |
| 100 | Cat 4 PRU |
| 101 | Cat 5 PRU |
| 110 | Reserved |
| 111 | Reserved |

If the wireless power receiver cannot cause an impedance shift, or if a Received Signal Strength Indication (RSSI) is greater than or equal to a predetermined value in spite of no load variation, the wireless power transmitter transmits a connection request signal to the wireless power receiver after receiving the AD signal from the wireless power receiver and starts communication.

If the wireless power receiver fails to receive the connection request signal due to a factor such as a communication failure, the wireless power transmitter may not receive a static parameter, attempt communication a predetermined time (for example, 500 ms) later, and receive an AD signal from the wireless power receiver.

If a timer has expired after N retries without a reception of an AD signal or a connection request signal, the wireless power transmitter determines that the wireless power receiver is not a normal wireless power receiver for charging (for example, the wireless power receiver is cross-connected) and reduces power transmission by entering the power save mode, the latch fault mode, or a local fault mode.

If the above situation occurs while the wireless power transmitter is charging another wireless power receiver (for example, in the power transfer mode), the wireless power transmitter reduces output power or continues power transmission by returning to the latch fault mode or the power save mode.

Referring to FIG. 12, if a load variation by the PRU is sensed after the PTU transmits a short beacon signal, a current Iₜₓ of a PTU coil is increased for transmission of a long beacon signal having greater power. The long beacon signal is maintained for a predetermined time (for example, 105 ms) for transmission, such that the MCU of the PRU is powered on to deliver the AD signal to the PTU.

If the AD signal transmitted from the PRU during the long beacon transmission time is sensed to have a signal strength of a predetermined level or greater, the PTU determines that the PRU is placed on the PTU, and then enters a low power mode. In the low power mode, the PTU maintains the power for a predetermined time (for example, 500 ms), and performs a PRU registration process to exchange charging information between the PTU and the PRU and to determine whether charging is possible.

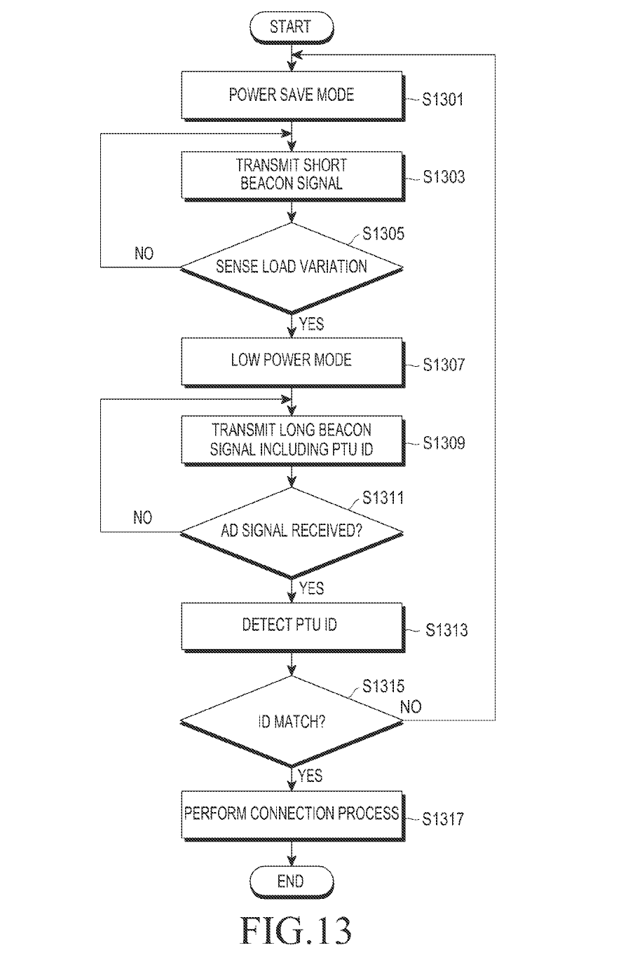

Hereinafter, a description is provided of methods for determining cross connection according to the present invention with reference to FIGS. 13 through 21.

FIG. 13 is a flowchart of a method of determining cross connection according to an embodiment of the present invention.

Referring to FIG. 13, in a power save mode in step S1301, a PTU transmits a short beacon signal in step S1303. If a load variation is sensed by a PRU in step S1305 by transmitting the short beacon signal, the PTU determines that the PRU is placed on the PTU.

Upon sensing a load variation, the PTU switches from the power save mode to the low power mode in step S1307 and transmits a long beacon signal. According to an embodiment of the present invention, the PTU transmits information for identifying the PTU through the long beacon signal in step S1309. For example, the PTU transmits identification information of the PTU, together with power for driving the PRU, to the PRU through in-band communication.

The IDentification (ID) information of the PTU is included in the long beacon signal in various manners. For example, before being transmitted, the long beacon signal may be modulated according to various modulation schemes based on the ID information of the PTU. In another embodiment of the present invention, a signal obtained by modulating the ID information of the PTU (for example, the current Iₜₓ modulated based on the ID information) may be combined with the long beacon signal for transmission.

According to an embodiment of the present invention, various modulation schemes may be used. For example, modulation may be performed using PPM or PWM, but embodiments of the present invention are not limited to these schemes. In addition, to reduce a change in the power received by the PRU, modulation may be performed using Manchester coding or the like.

The MCU of the PRU is driven by a long beacon signal transmitted from the PTU, and the PRU detects ID information of the PTU, included in the received long beacon signal.

The PRU driven by the long beacon signal transmits an AD signal for searching for the PTU through a communication unit (for example, the communication unit illustrated in FIG. 3A, FIG. 3B, or FIG. 3C). According to an embodiment of the present invention, the detected ID information of the PTU or preset information corresponding to the ID information of the PTU is transmitted through the AD signal.

Once the AD signal transmitted from the PRU is received in step S1311, the PTU detects PTU ID information from the received AD signal in step S1313. If the detected PTU ID information matches the ID information of the PTU, transmitted through the long beacon signal, in step S1315, the PTU determines a normal connection and performs a connection process in step S1317. In contrast, if the detected PTU ID information does not match the ID information of the PTU transmitted through the long beacon signal in step S1315, the PTU determines cross connection and does not perform the connection process or returns to the power save mode.

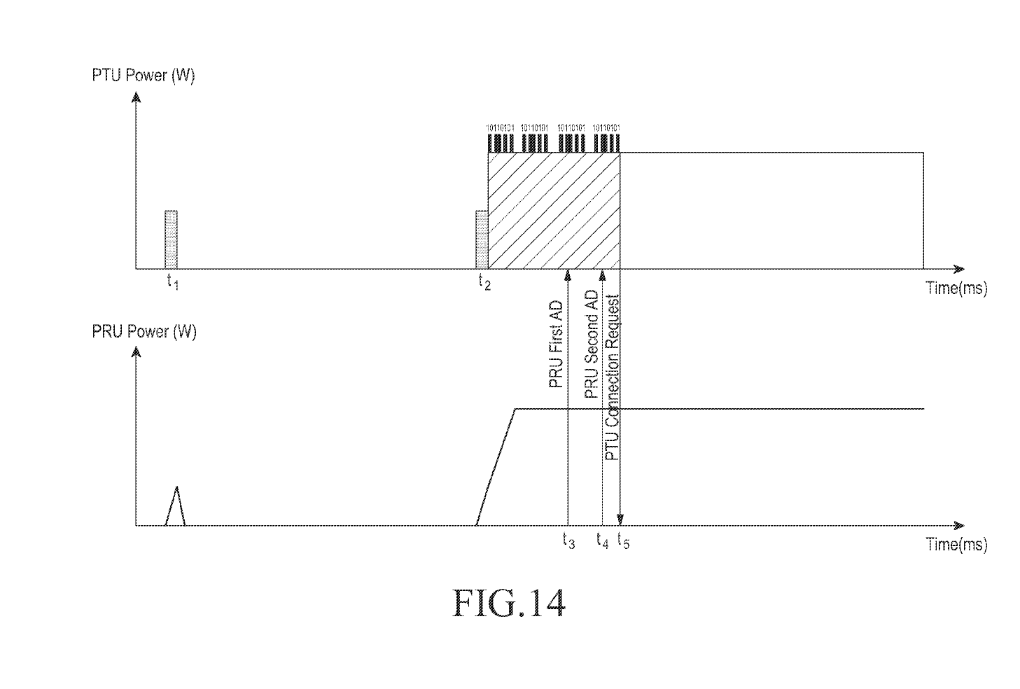

FIG. 14 is a graph a method of determining cross connection according to an embodiment of the present invention.

Referring to FIG. 14, upon sensing a load variation in the power save mode, the PTU switches to the low power mode and increases power by increasing a current Iₜₓ of a PTU coil to transmit a long beacon. According to an embodiment of the present invention, for transmission, the current Iₜₓ is modulated into a particular signal such as PTU ID information (for example, “10110101” in FIG. 14) at predetermined intervals. The PTU may use a modulation scheme such as PPM or PWM, and to reduce a change in the power of a signal transmitted by the PRU, Manchester coding may be used. The ID information of the PTU may be repetitively transmitted during a preset time (for example, 105 ms).

Once power is applied to the PRU by the signal transmitted by the PTU, the MCU inside the PRU is driven and the PTU ID information included in the transmitted power signal is detected.

The PRU transmits the detected PTU ID information through an out-band signal (for example, BLE, Zigbee, or the like). For example, the PRU may transmit the detected PTU ID information through an AD signal transmitted for searching for the PTU.

The PTU having received the AD signal from the PRU determines whether the PTU ID information transmitted through the power signal (for example, the long beacon signal) matches the PTU ID information included in the AD signal transmitted by the PRU. If they match, the PTU transmits a connection request to the PRU to establish an out-band connection with the PRU. The PTU enters the low power state to start a registration process. In contrast, if both the PTU ID information do not match, the PTU ignores the received AD signal and returns to the power save mode to transmit a short beacon.

According to an embodiment of the present invention, if PTU ID information included in a first AD signal does not match previously transmitted PTU ID information, the PTU repeats transmission a predetermined number of times. The PTU transmits identical PTU ID information or different PTU ID information every re-transmission. In addition, a change interval of the PTU ID information may be set considering an AD signal transmission interval of the PRU.

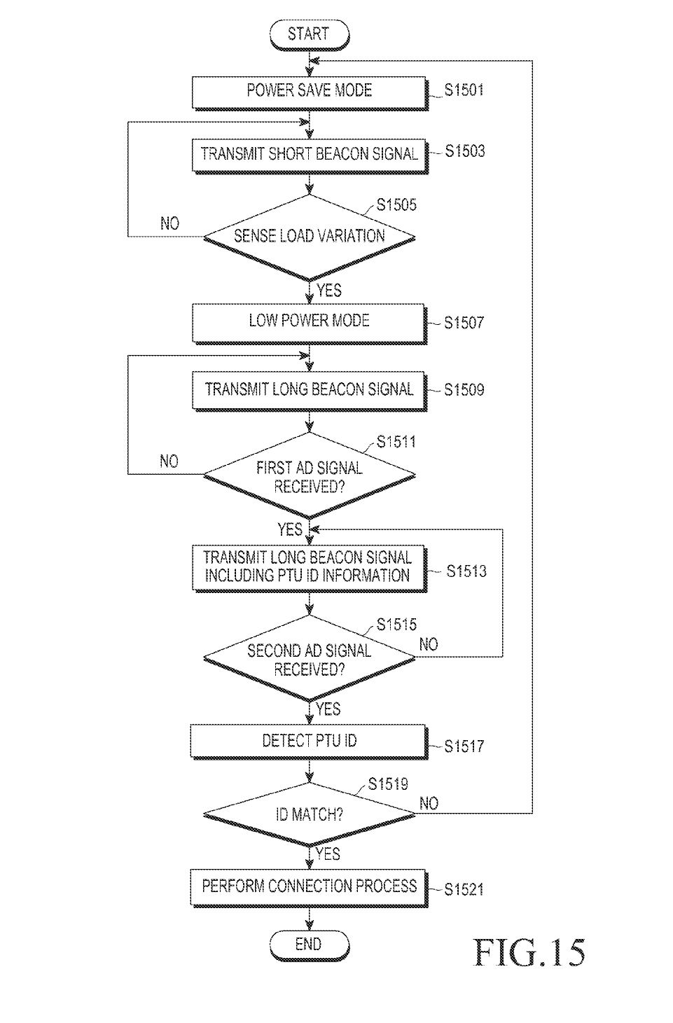

FIG. 15 is a flowchart of a method of determining cross-connection according to an embodiment of the present invention.

Referring to FIG. 15, in the power save mode in step S1501, a PTU transmits a short beacon signal in step S1503. If a load variation by the PRU is sensed in step S1505 by transmitting the short beacon signal, the PTU determines that the PRU is placed on the PTU.

Upon sensing a load variation, the PTU switches from the power save mode to the low power mode in step S1507 and transmits a long beacon signal in step S1509.

The MCU inside the PRU is driven by the long beacon signal transmitted from the PTU, and the PRU driven by the long beacon signal transmits a first AD signal for searching for the PTU through a communication unit (for example, the communication unit illustrated in FIG. 3A, FIG. 3B, or FIG. 3C).

Upon receiving the first AD signal transmitted from the PRU in step S1511, the PTU transmits information for identifying the PTU through a transmission of a long beacon signal in step S1513. For example, the PTU transmits ID information of the PTU, together with power for driving the PRU, to the PRU through an in-band communication.

The PTU ID information may be included in the long beacon signal in various ways. For example, the long beacon signal may be transmitted after being modulated using various modulation schemes based on the PTU ID information. According to another embodiment of the present invention, a signal obtained by modulating the PTU ID information (for example, modulating the current Iₜₓ based on the ID information) may be combined with the long beacon signal for transmission.

According to an embodiment of the present invention, various modulation schemes may be used. For example, modulation may be performed using PPM or PWM, and the present invention is not limited to these schemes. To reduce a change in the power received by the PRU, modulation may be performed using Manchester coding or the like.

The PRU having received the long beacon signal from the PTU detects ID information of the PTU, included in the received long beacon signal. The PRU transmits the detected ID information of the PTU or preset information corresponding to the ID information of the PTU through a next transmission AD signal (which is referred to as a second AD signal for convenience) according to an embodiment of the present invention.

Upon receiving the second AD signal transmitted from the PRU in step S1515, the PTU detects the PTU ID information from the received AD signal in step S1517. If the detected PTU ID information matches the ID information of the PTU transmitted through the long beacon signal in step S1519, the PTU determines a normal connection and performs a connection process in step S1521. In contrast, if the detected PTU identification information does not match the ID information of the PTU transmitted through the long beacon signal in step S1519, the PTU determines cross connection and does not perform the connection process or returns to the power save mode.

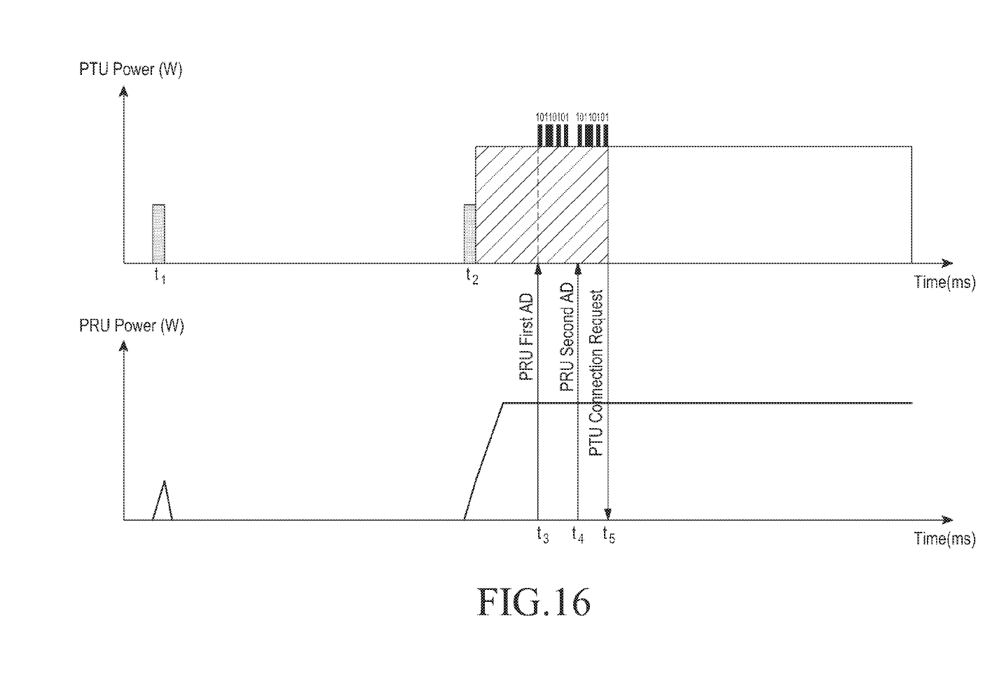

FIG. 16 is a graph illustrating a method of determining cross connection according to an embodiment of the present invention.

Referring to FIG. 16, upon sensing a load variation in the power save mode, the PTU switches to the low power mode and increases power by increasing the current Iₜₓ of the PTU coil to transmit a long beacon.

If power is applied to the PRU by a signal transmitted by the PTU, the MCU inside the PRU is driven and an AD signal is transmitted through out-band signaling (for example, BLE, Zigbee, or the like) to search for the PTU.

Upon receiving a first AD signal, the PTU modulates the current Iₜₓ into a signal such as PTU ID information (for example, “10110101” in FIG. 16) at predetermined intervals for transmission according to an embodiment of the present invention. In this case, the PTU may use modulation such as PPM, PWM, or the like, and to reduce a change in the power of the signal transmitted by the PRU, Manchester coding may be used. ID information of the PTU may be transmitted repetitively for a preset time (for example, 105 ms).

The PRU having received the long beacon signal from the PTU detects ID information of the PTU, included in the received long beacon signal. The PRU transmits the detected ID information of the PTU or preset information corresponding to the ID information of the PTU through a transmission of an AD signal, the second AD signal, according to an embodiment of the present invention.

The PTU having received the second AD signal from the PRU determines whether the PTU ID information transmitted through the power signal (for example, the long beacon signal) transmitted by the PTU matches the PTU ID information included in the second AD signal transmitted by the PRU. If the transmitted PTU ID information matches the included PTU ID information, the PTU transmits a connection request to the PRU to establish an out-band connection with the PRU. The PTU enters the low power mode to start a registration process. In contrast, if the transmitted PTU ID information and the included PTU ID information do not match, the PTU ignores the received AD signal and returns to the power save mode to transmit a short beacon.

According to an embodiment of the present invention, if the PTU ID information included in the second AD signal received by the PTU does not match previously transmitted PTU ID information, the PTU must repeat transmission a predetermined number of times. In this case, the PTU transmits identical PTU ID information or different PTU ID information every re-transmission. A change interval of the PTU ID information is set considering an AD signal transmission interval of the PRU.

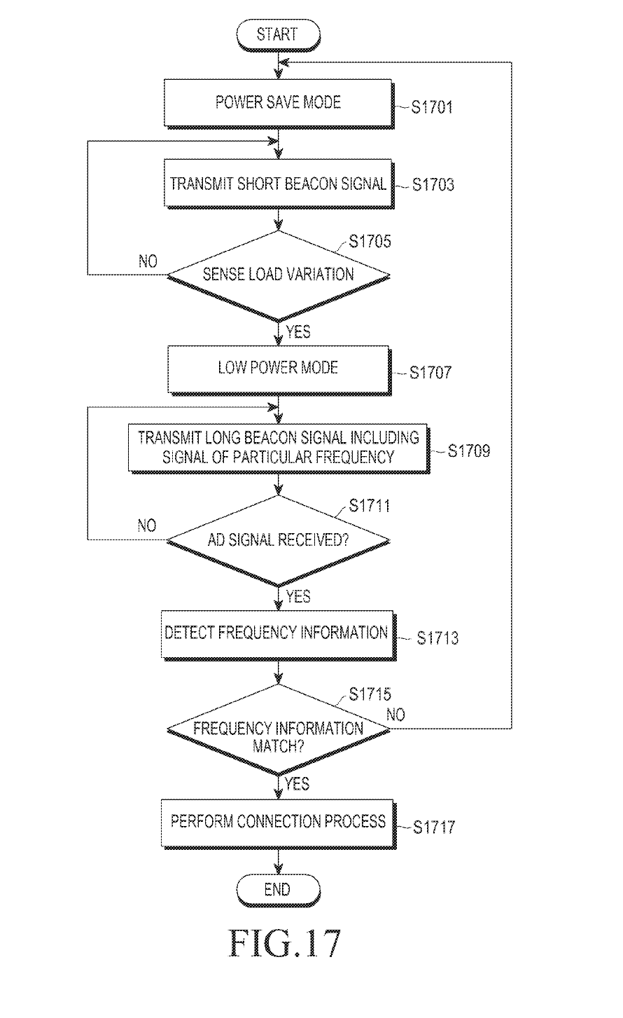

FIG. 17 is a flowchart of a method of determining cross-connection according to an embodiment of the present invention.

Referring to FIG. 17, in the power save mode in step S1701, the PTU transmits a short beacon signal in step S1703. Upon sensing a load variation by the PRU in step S1705 by transmitting the short beacon signal, the PTU determines that the PRU is disposed on the PTU.

After sensing a load variation, the PTU switches from the power save mode to the low power mode in step S1707, and transmits a long beacon signal. According to an embodiment of the present invention, information for identifying the PTU is transmitted through the long beacon signal in step S1709. For example, the PTU may transmit ID information of the PTU, together with power for driving the PRU, to the PRU through an in-band communication.

The ID information of the PTU is included in the long beacon signal in various manners. For example, according to an embodiment of the present invention, a signal of a preset frequency (or a preset frequency signal) is transmitted through the long beacon signal. The frequency signal may be a square wave, a pulse signal, or the like, and the present invention is not limited to a particular signal form. In addition, to reduce a change in the power received in the PRU, modulation may be performed using Manchester coding or the like. The frequency signal may be repetitively transmitted in a period of transmission of the long beacon signal.

The MCU inside the PRU is driven by the long beacon signal transmitted from the PTU, and the PRU detects the frequency signal, included in the received long beacon signal. In this case, the PRU may use a separately added circuit for detection of the frequency signal, and may detect a rectified voltage or current of the received signal by using an Analog-to-Digital Converter (ADC) of the MCU. According to an embodiment of the present invention, to facilitate frequency detection, a Fast Fourier Transform (FFT) may be used. As a result of the frequency detection, the closest frequency value among a plurality of preset frequencies may be determined as the detected frequency value.

The PRU driven by the long beacon signal transmits an AD signal for searching for the PTU through a communication unit (for example, the communication unit illustrated in FIG. 3A, FIG. 3B, or FIG. 3C). According to an embodiment of the present invention, the detected frequency information may also be transmitted through the AD signal.

Upon receiving the AD signal transmitted from the PRU in step S1711, the PTU detects the frequency information from the received AD signal in step S1713. If the detected frequency information matches the frequency information of the signal transmitted through the long beacon signal in step S1715, the PTU determines a normal connection and performs a connection process in step S1717. In contrast, if the detected frequency information does not match the frequency information of the signal transmitted through the long beacon signal in step S1715, then the PTU determines a cross connection and does not perform the connection process or returns to the power save mode.

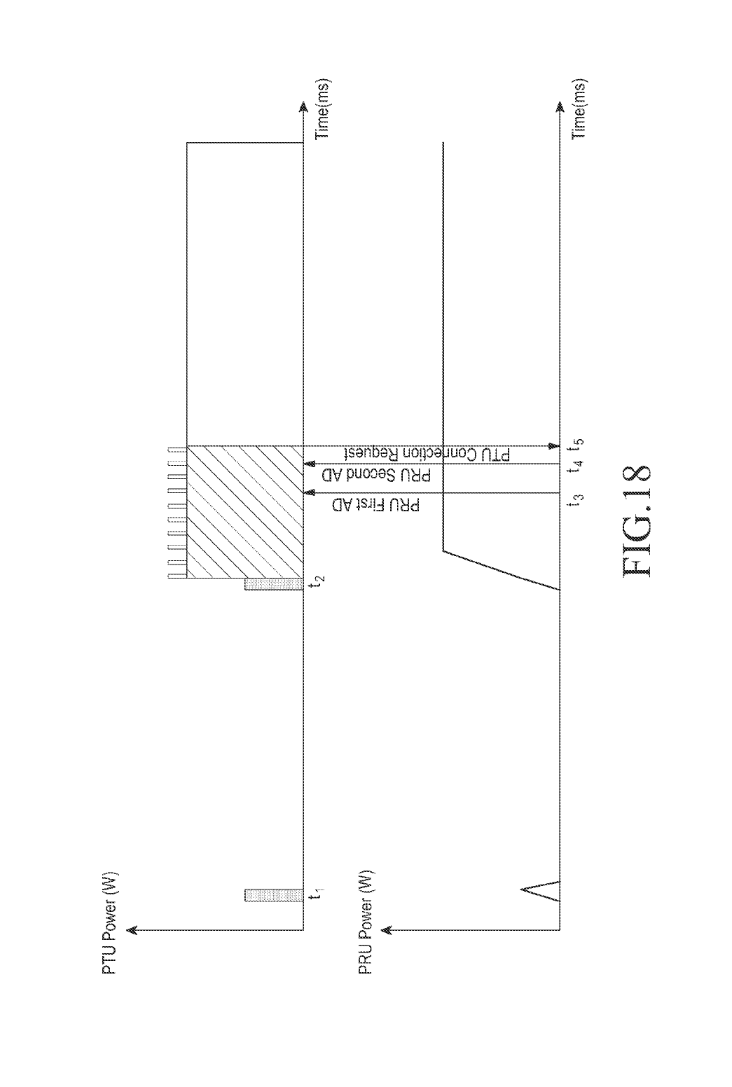

FIG. 18 is a graph illustrating a method of determining cross connection according to an embodiment of the present invention. Referring to FIG. 18, the PTU switches to the low power mode upon sensing a load variation in the power save mode, and increases power by increasing the current Iₜₓ of the PTU coil to transmit a long beacon. According to an embodiment of the present invention, a preset frequency signal is transmitted through the long beacon signal at predetermined intervals. The PTU generates the frequency signal in the form of square waves or pulses. To reduce a change in the power received by the PRU, the signal is modulated using Manchester coding or the like. The frequency signal may be repetitively transmitted during transmission of the long beacon signal.

If power is applied to the PRU by the signal transmitted by the PTU, the MCU inside the PRU is driven and the frequency signal included in the transmitted power signal is detected.

The PRU transmits information about the frequency of the detected signal through out-band signaling (for example, BLE, Zigbee, or the like). For example, the frequency information of the detected signal is transmitted through the AD signal transmitted by the PRU to search for the PTU.

The PTU having received the AD signal from the PRU determines whether the frequency information of the particular-frequency signal transmitted through the power signal (for example, the long beacon signal) matches the frequency information included in the AD signal transmitted by the PRU. If both the frequency information match, the PTU transmits a connection request to the PRU to establish out-band connection with the PRU. Then, the PTU enters the low power mode to start a registration process. In contrast, if the frequency information does not match, the PTU ignores the received AD signal and returns to the power save mode to transmit a short beacon.

According to an embodiment of the present invention, if the frequency information included in a first AD signal received by the PTU does not match frequency information of a previously transmitted signal, the PTU repeats transmission a predetermined number of times. In this case, the PTU transmits a signal of an identical or different frequency every re-transmission. A frequency change interval of the frequency signal is set considering an AD signal transmission interval of the PRU.

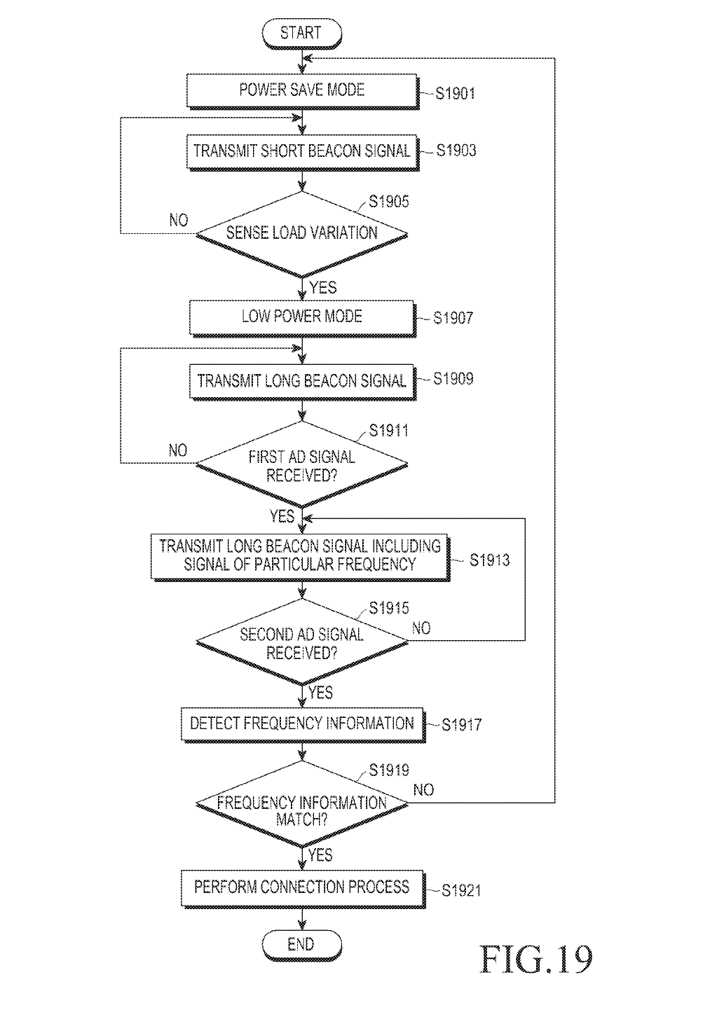

FIG. 19 is a flowchart of a method of determining cross-connection according to an embodiment of the present invention.

Referring to FIG. 19, in the power save mode in step S1901, the PTU transmits a short beacon signal in step S1903. Upon sensing a load variation by the PRU in step S1905 by transmitting the short beacon signal, the PTU determines that the PRU is placed on the PTU.

After sensing a load variation, the PTU switches from the power save mode to the low power mode in step S1907 and transmits a long beacon signal in step S1909.

The MCU inside the PRU is driven by the long beacon signal transmitted from the PTU, and the PRU driven by the long beacon signal transmits a first AD signal for searching for the PTU through a communication unit (for example, the communication illustrated in FIG. 3A, FIG. 3B, or FIG. 3C).

Upon receiving the first AD signal transmitted from the PRU in step S1911, the PTU transmits a preset frequency signal through a transmission of a long beacon signal according to an embodiment of the present invention in step S1913. For example, the PTU transmits the frequency signal, together with power for driving the PRU, to the PRU through in-band communication.

The frequency signal is transmitted through the long beacon signal in various manners. For example, according to an embodiment of the present invention, a preset frequency signal is transmitted through the long beacon signal. The frequency signal may be a square wave or pulse signal, and an embodiment of the present invention is not limited to a particular signal form. To reduce a change in the power received in the PRU, modulation is performed using Manchester coding or the like. The frequency signal may be transmitted repetitively during transmission of the long beacon signal.

The PRU having received the long beacon signal from the PTU detects the particular-frequency signal included in the received long beacon signal. The PRU may use a circuit separately added for the detection of the frequency signal, and rectified the voltage or current of the received signal may be detected using an ADC of the MCU. According to an embodiment of the present invention, to facilitate frequency detection, an FFT may be used. As a result of the frequency detection, the closest frequency value among a plurality of preset frequencies may be determined as the detected frequency value.

The PRU transmits the frequency information of the detected signal through a transmission of the AD signal, a second AD signal, according to an embodiment of the present invention.

Upon receiving the second AD signal transmitted from the PRU in step S1915, the PTU detects the frequency information from the received AD signal in step S1917. If the detected frequency information matches frequency information of the frequency signal transmitted through the long beacon signal in step S1919, the PTU determines a normal connection and performs the connection process in step S1921. In contrast, if the detected frequency information does not match the frequency information of the signal transmitted through the long beacon signal in step S1919, the PTU determines cross connection and does not perform the connection process or returns to the power save mode.

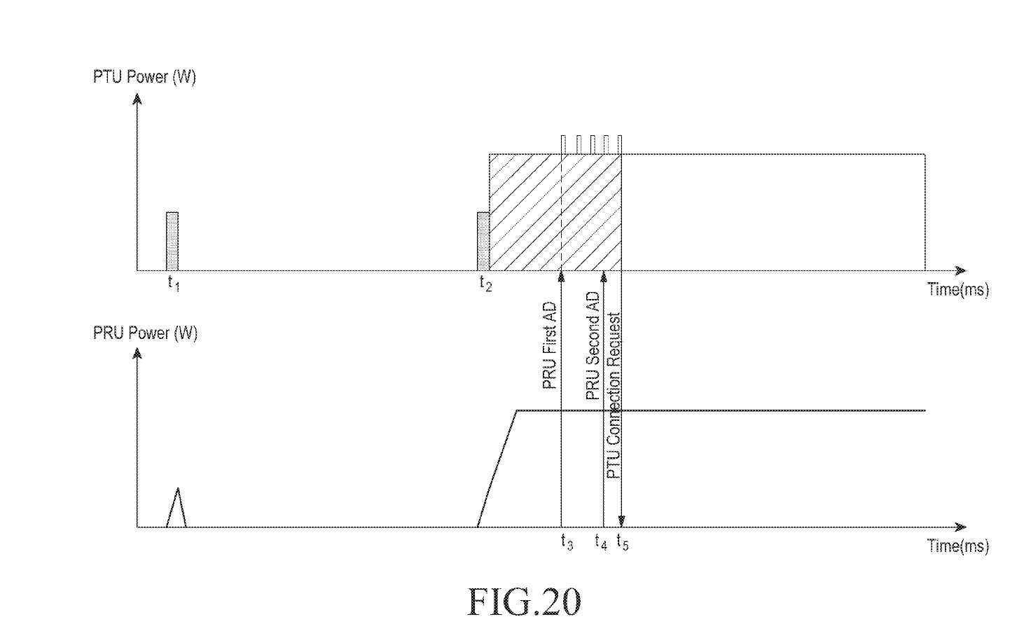

FIG. 20 is a graph illustrating a method of determining cross connection according to an embodiment of the present invention.

Referring to FIG. 20, upon sensing a load variation in the power save mode, the PTU switches to the low power mode and increases power by increasing the current Iₜₓ of the PTU coil to transmit a long beacon.

If power is applied to the PRU by the signal transmitted by the PTU, the MCU inside the PRU is driven and the AD signal for searching for the PTU is transmitted through out-band signaling (for example, BLE, Zigbee, or the like).

Upon receiving the first AD signal, the PTU transmits a frequency signal through a long beacon signal at predetermined intervals according to an embodiment of the present invention. The frequency signal may be a square wave, a pulse wave, or the like, and an embodiment of the present invention is not limited to a particular signal form. To reduce a change in the power received by the PRU, modulation is performed using Manchester coding or the like. The frequency signal may be repetitively transmitted during transmission of the long beacon signal.

The PRU having received the long beacon signal from the PTU detects the frequency signal included in the received long beacon signal. The PRU transits frequency information of the detected signal through a transmission of the AD signal, the second AD signal, according to an embodiment of the present invention.

The PTU having received the second AD signal from the PRU determines whether the frequency information of the frequency signal transmitted through a power signal (for example, the long beacon signal) matches frequency information included in the second AD signal transmitted by the PRU. If both the frequency information match, the PTU transmits a connection request to the PRU to establish out-band connection with the PRU. The PTU enters the low power mode to start a registration process. If both the frequency information does not match, the PTU ignores the received AD signal and returns to the power save mode to transmit a short beacon.

According to an embodiment of the present invention, if the frequency information included in the second AD signal received by the PTU does not math frequency information of a previously transmitted signal, the PTU repeats transmission a predetermined number of times. The PTU transmits a signal of an identical or different frequency every re-transmission. A frequency change interval of the signal is set considering an AD signal transmission interval of the PRU.

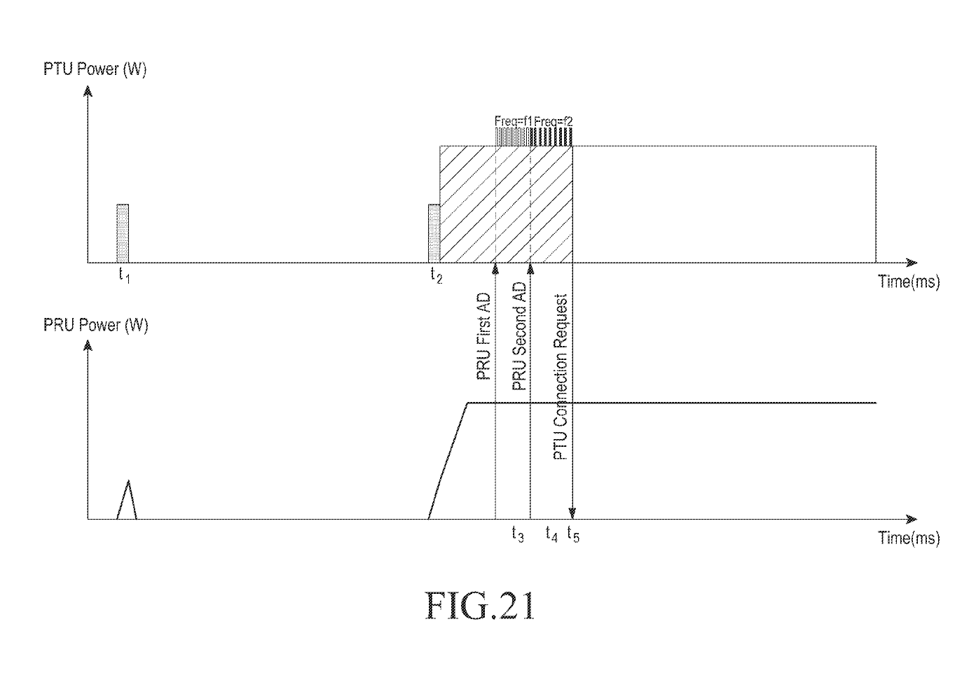

FIG. 21 is a graph illustrating a method of determining cross-connection according to an embodiment of the present invention. Referring to FIG. 21, in the same manner as in an above-described embodiment of the present invention, the PTU transmits a frequency signal to the PRU through a long beacon signal and the PRU detects a frequency of the signal transmitted from the PTU.

The PTU performs a confirmation process by transmitting a signal of another frequency to the PRU, even if frequency information included in an AD signal transmitted after the second transmission matches preset frequency information. For example, by re-transmitting a plurality of signals of different frequencies to the PRU, the PTU confirms that the signal is an out-band signal transmitted from the PRU located within a charging area of the PTU. In this way, the accuracy of detection of a cross connection is improved.

According to an embodiment of the present invention, after receiving an initial AD signal (e.g. the first AD signal), if the PTU transmits a signal at a first frequency (e.g. frequency #1), and transmits a signal at a second frequency (e.g. frequency #2) after receiving a second AD signal, then the PRU transmits the first frequency information and the second frequency information together through each AD signal. In this case, the PTU is implemented to transmit a connection request to the PRU when information of the first frequency and information of the second frequency included in AD signals received from the PRU correspond to the first frequency and the second frequency of the signals transmitted by the PTU.

In this case, if frequency information received from the PRU matches only one of the different frequencies of a plurality of transmitted signals, the PTU extends a transmission period of a long beacon signal by a preset time, and repetitively transits a signal until plural (for example, 2) frequency information match the received frequency information or a predetermined number of times.

According to an embodiment of the present invention, if one or more PRUs are being charged, the PTU continuously modulates and transits a power signal, and modulates the power signal at predetermined time intervals to reduce interference with charging of another PRU, which may occur due to signal transmission.

When the power signal is modulated and transmitted at the predetermined time intervals to sense cross connection, the power signal may be modulated and transmitted only in a period when an out-band communication medium searches for a new device (for example, a Scan Window (70 ms) of BLE).

As is apparent from the foregoing description, a problem encountered when a wireless power transmitter is connected to a wireless power receiver placed on another wireless power transmitter and charges the wireless power receiver can be overcome according to an embodiment of the present invention.

While the present invention has been shown and described with reference to certain embodiments thereof, it will be understood by those skilled in the art that various changes in form and details may be made therein without departing from the scope and spirit of the present invention as defined by the appended claims and their equivalents.

What is claimed is:

1. A method of preventing cross connection in wireless charging, the method comprising:
determining whether a load variation is sensed in a wireless power transmitter,
transmitting a signal comprising identification information of the wireless power transmitter if the load variation is sensed;
receiving a signal transmitted from at least one wireless power receiver, and
performing a communication connection with the at least one wireless power receiver having transmitted the signal, if information included in the received signal matches the identification information of the wireless power transmitter.

2. The method of claim 1, wherein the identification information of the wireless power transmitter is transmitted through a long beacon signal.

3. The method of claim 2, wherein the identification information of the wireless power transmitter is identified by sensing power of a predetermined strength or greater in the long beacon signal.

4. The method of claim 1, wherein the identification information of the wireless power transmitter comprises at least one binary data.

5. The method of claim 1, wherein the identification information of the wireless power transmitter is transmitted by modulating a current signal transmitted by the wireless power transmitter based on the identification information.

6. The method of claim 1, wherein the signal transmitted from the at least one wireless power receiver is an advertisement signal.

7. The method of claim 1, wherein the identification information of the wireless power transmitter is repetitively transmitted in a preset time.

8. The method of claim 1, wherein if information included in the received signal does not match the identification information of the wireless power transmitter, the wireless power transmitter switches to a power save mode to transmit a short beacon signal.

9. The method of claim 1, further comprising re-transmitting a signal comprising the identification information of the wireless power transmitter, if information included in the received signal does not match the identification information of the wireless power transmitter.

10. The method of claim 9, wherein the identification information included in the re-transmitted signal is different from the identification information included in a previously transmitted signal.

11. The method of claim 1, wherein the identification information of the wireless power transmitter corresponds to a preset frequency, and a signal of the preset frequency is transmitted through a long beacon signal.

12. The method of claim 11, wherein the signal of the preset frequency is a signal in the form of square waves or pulses.

13. The method of claim 11, further comprising re-transmitting a signal comprising the identification information of the wireless power transmitter, if the information included in the received signal does not match the identification information of the wireless power transmitter.

14. The method of claim 13, wherein the re-transmitted signal is of a frequency that is different from the preset frequency of a previously transmitted signal.

15. A method of preventing cross connection in wireless charging, the method comprising:
transmitting, by a wireless power transmitter, a short beacon signal;
determining whether a load variation is sensed in the wireless power transmitter;
transmitting, by the wireless power transmitter, a long beacon signal if the load variation is sensed;
receiving a first signal transmitted from at least one wireless power receiver,
transmitting a long beacon signal comprising identification information of the wireless power transmitter, corresponding to the reception of the first signal;
receiving a second signal transmitted from at least one wireless power receiver, and
performing a communication connection with the at least one wireless power receiver having transmitted the signal, if information included in the received second signal matches the identification information of the wireless power transmitter.

16. The method of claim 15, wherein the identification information of the wireless power transmitter is identified by sensing power of a predetermined strength or greater in the long beacon signal.

17. The method of claim 15, wherein the identification information of the wireless power transmitter comprises at least one binary data.

18. The method of claim 15, wherein the identification information of the wireless power transmitter is transmitted by modulating a current signal transmitted by the wireless power transmitter based on the identification information.

19. The method of claim 15, wherein the first signal or the second signal is an advertisement signal.

20. The method of claim 15, wherein the identification information of the wireless power transmitter is repetitively transmitted in a preset time.

21. The method of claim 15, wherein if the information included in the received signal does not match the identification information of the wireless power transmitter, the wireless power transmitter switches to a power save mode to transmit a short beacon signal.

22. The method of claim 15, further comprising re-transmitting a signal comprising the identification information of the wireless power transmitter, if the information included in the received signal does not match the identification information of the wireless power transmitter.

23. The method of claim 22, wherein the identification information included in the re-transmitted signal is different from the identification information included in a previously transmitted signal.

24. The method of claim 15, wherein the identification information of the wireless power transmitter corresponds to a preset frequency, and a signal of the preset frequency is transmitted through a long beacon signal.

25. The method of claim 24, wherein the signal of the preset frequency is a signal in the form of square waves or pulses.

26. The method of claim 22, further comprising re-transmitting a signal comprising the identification information of the wireless power transmitter, if the information included in the received signal does not match the identification information of the wireless power transmitter.

27. The method of claim 26, wherein the re-transmitted signal is of a frequency that is different from a frequency of a previously transmitted signal.
